(19) United States
(12) Patent Application Publication
(10) Pub. No.: US 2019/0235134 A1
(43) Pub. Date: Aug. 1, 2019

(54) ANTIREFLECTION FILM, POLARIZING PLATE, IMAGE DISPLAY DEVICE, ANTIREFLECTION PRODUCT, METHOD OF MANUFACTURING LAMINATE, AND METHOD OF MANUFACTURING ANTIREFLECTION FILM

(71) Applicant: FUJIFILM Corporation, Tokyo (JP)

(72) Inventors: Shuntaro IBUKI, Kanagawa (JP); Miho ASAHI, Kanagawa (JP); Shinya WATANABE, Kanagawa (JP)

(73) Assignee: FUJIFILM Corporation, Tokyo (JP)

(21) Appl. No.: 16/380,391

(22) Filed: Apr. 10, 2019

Related U.S. Application Data
(63) Continuation of application No. PCT/JP2017/034209, filed on Sep. 22, 2017.

(30) Foreign Application Priority Data
Oct. 17, 2016 (JP) 2016-203905

(51) Int. Cl. G02B 1/118; G02B 1/14; B29D 11/00

(52) U.S. Cl. CPC G02B 1/118; G02B 1/14; G02B 5/3025; B29D 11/00865; B29D 11/0074

(57) ABSTRACT

In an antireflection film, an antireflection layer is laminated on a support having a transmittance of 80% or more, and a reflectance difference before and after the deformation in a case of outward bending or inward bending with R of 0.8 mm in biaxial directions different by 90° is within 1.0%.

### CROSS-REFERENCE TO RELATED APPLICATIONS

This application is a Continuation of PCT International Application No. PCT/JP2017/034209, filed on Sep. 22, 2017, which claims priority under 35 U.S.C. § 119(a) to Japanese Patent Application No. 2016-203905, filed on Oct. 17, 2016. Each of the above application(s) is hereby expressly incorporated by reference, in its entirety, into the present application.

### BACKGROUND OF THE INVENTION

### 1. Field of the Invention

The present invention relates to an antireflection film, a polarizing plate, an image display device, an antireflection product, a method of manufacturing a laminate, and a method of manufacturing an antireflection film.

### 2. Description of the Related Art

In an image display device such as a display device using a cathode ray tube (CRT), a plasma display panel (PDP), an electroluminescent display (ELD), a vacuum fluorescent display (VFD), a field emission display (FED), and a liquid crystal display (LCD), an antireflection film may be provided in order to prevent decrease in the contrast due to reflection of external light on a display surface and reflected glare of an image. In addition to the image display device, the antireflection function may be provided to a glass surface of the showroom or the like by an antireflection film.

As the antireflection film, an antireflection film having a tine uneven shape with a period equal to or less than the wavelength of visible light on the surface of a substrate, that is, an antireflection film having a so-called moth eye structure is known. The moth eye structure makes a refractive index gradient layer in which the refractive index successively changes in a pseudo manner from the air toward the bulk material inside the substrate, and reflection of the light can be prevented.

In recent years, a flexible display device using a resin substrate having flexibility instead of a glass substrate has been proposed. It is desired that the antireflection film used for such a display device also has flexibility. For example, JP2016-075869A discloses a transparent antireflection film having flexibility applicable to a flexible display device, which comprises an antireflection layer containing two layers of inorganic fine particles and a matrix resin on a substrate.

JP2009-020355A discloses an antireflection structure having a periodic structure of equal to or less than the wavelength of visible light and comprising a substantially conical microprojection having a ridge line shape, in which abrasion can be prevented by hard particles mixed near a surface of the projection, and breakage is prevented by the flexibility of the resin constituting the projections.

### SUMMARY OF THE INVENTION

In order to apply the antireflection film to a product having a three-dimensional shape or the like, the product can be bent without causing cracks with a smaller radius of curvature while a low reflectance is maintained, and high bending resistance which is three-dimensionally followable is required.

However, in the antireflection film disclosed in JP2016-075869A, it is disclosed that bending resistance with a radius of curvature of 2 mm, scratch resistance, and transparency can be obtained, but a low reflectance of about 1% to 2% may not be realized. In the antireflection structure disclosed in JP2009-020355A, it is described that a low reflectance can be obtained, and the breaking elongation of microprojections is improved, but an antireflection structure is formed on a substrate, and the bending resistance of the antireflection structure including the substrate is not disclosed.

The present invention has been conceived in view of the above circumstances, and an object thereof is to provide an antireflection film which has high bending resistance and transparency and can suppress fluctuation of reflectance before and after bending. Another object of the present invention is to provide a polarizing plate, an antireflection product, and an image display device in which such an antireflection film is used. Still another object of the present invention is to provide a manufacturing method for easily obtaining such an antireflection film and a laminate including the antireflection film.

An antireflection film according to the embodiment of the present invention comprises a support having a transmittance of 80% or more; and an antireflection layer laminated on the support, in which a reflectance difference before and after deformation in a case of outward bending or inward bending with R of 0.8 mm in biaxial directions different by 90° is within 1.0%.

It is preferable that the antireflection layer includes a binder and a fine particle and has a periodic structure having a period equal to or less than a visible light wavelength of 380 nm, the fine particle has an average primary particle diameter of 150 nm to 250 nm, the binder includes at least one of polyacrylate or polyurethane acrylate, and an elongation rate of the antireflection film is 10% or more.

It is preferable that a hardness of the fine particle is 400 MPa or more.

The antireflection film according to the embodiment of the present invention may comprise a hard coat layer between the support and the antireflection layer.

It is preferable that a thickness of the hard coat layer is 10 μm or less.

It is preferable that, in the antireflection film according to the embodiment of the present invention, an elongation rale of the support is 20% or more.

It is preferable that a thickness of the support is 60 μm or less.

It is preferable that a surface of the antireflection layer repeatedly includes regions where an etching rate in a case where the surface of the antireflection layer is etched with argon gas plasmatized at 13.56 MHz differs by 10 times or more, at a period of 380 nm or less.

It is preferable that, in the antireflection film according to the embodiment of the present invention, in a case where steel wool of a grade (count) #0000 which is manufactured by Nippon Steel Wool Co., Ltd (product number B-204) is wrapped around a front end section of a 1 cm square of a rubbing tester, and a surface of the antireflection layer opposite to the support is rubbed with a load of 50 g/cm², a reflectance difference between a rubbed portion and a non-rubbed portion is within 0.2%.

It is preferable that, in the antireflection film according to the embodiment of the present invention, a reflectance difference before and after deformation in a case of outward bending with R of 0.8 mm in triaxial directions different by 60° is within 1.0%.

A polarizing plate according to the embodiment of the present invention comprises the antireflection film according to the embodiment of the present invention as a protective film.

An image display device according to the embodiment of the present invention comprises the antireflection film or the polarizing plate according to the embodiment of the present invention.

An antireflection product according to the embodiment of the present invention comprises the antireflection film according to the embodiment of the present invention.

A method of manufacturing a laminate according to the embodiment of the present invention comprises, in this order:

a first step of coating a support with a curable composition including a curable compound and a fine particle having an average primary particle diameter of 150 nm to 250 nm and a hardness of 400 MPa or more, to provide a first layer in a thickness in which the fine particle is buried in the first layer including the curable compound;

a second step of bonding a pressure sensitive adhesive layer of a pressure sensitive adhesive film having a substrate and the pressure sensitive adhesive layer provided on the substrate to a surface of the first layer opposite to the support;

a third step of lowering a position of an interface between the first layer and the pressure sensitive adhesive layer to the support side such that the fine particle is buried in a layer obtained by combining the first layer and the pressure sensitive adhesive layer and the fine particle protrudes from the interface opposite to an interface of the first layer on the support side; and

a fourth step of curing the first layer in a state in which the fine particle is buried in the layer obtained by combining the first layer and the pressure sensitive adhesive layer,

in which an elongation rate after the pressure sensitive adhesive film is peeled off is 10% or more.

A method of manufacturing an antireflection film according to the embodiment of the present invention comprise, in this order:

a first step of coating a support with a curable composition including a curable compound and a fine particle having an average primary particle diameter of 150 nm to 250 nm and a hardness of 400 MPa or more, to provide a first layer in a thickness in which the fine particle is buried in the first layer including the curable compound;

a second step of bonding a pressure sensitive adhesive layer of a pressure sensitive adhesive film having a substrate and the pressure sensitive adhesive layer provided on the substrate to a surface of the first layer opposite to the support;

a third step of lowering a position of an interface between the first layer and the pressure sensitive adhesive layer to the support side such that the fine particle is buried in a layer obtained by combining the first layer and the pressure sensitive adhesive layer and the fine particle protrudes from the interface opposite to an interface of the first layer on the support side;

a fourth step of curing the first layer in a state in which the fine particle is buried in the layer obtained by combining the first layer and the pressure sensitive adhesive layer; and

a fifth step of peeling off the pressure sensitive adhesive film,

in which an elongation rate is 10% or more.

With respect to the antireflection film according to the embodiment of the present invention, high bending resistance and transparency are provided, and fluctuation of the reflectance before and after bending can be suppressed.

The polarizing plate, the image display device, and the antireflection product according to the embodiment of the present invention comprise antireflection films according to the embodiment of the present invention and thus have high bending resistance and transparency such that fluctuation of the reflectance before and after bending is satisfactorily suppressed.

With respect to the method of manufacturing the laminate and the method of manufacturing the antireflection film according to the embodiment of the present invention, it is possible to easily obtain the antireflection film having an excellent antireflection function in a wavelength range of visible light and the high bending resistance and transparency and a laminate including the antireflection film.

### BRIEF DESCRIPTION OF THE DRAWINGS

FIG. 1 is a schematic cross-sectional view of an antireflection film according to the embodiment of the present invention.

FIG. 2 is a schematic cross-sectional view of a method of manufacturing a laminate according to the embodiment of the present invention.

FIG. 3 is a schematic cross-sectional view of a polarizing plate comprising the antireflection film according to the embodiment of the present invention.

FIG. 4 is a schematic cross-sectional view of an IPS-type liquid crystal display device which is an embodiment of an image display device of the present invention.

### DESCRIPTION OF THE PREFERRED EMBODIMENTS

Hereinafter, the present invention is described with reference to the drawings.

[Antireflection Film]

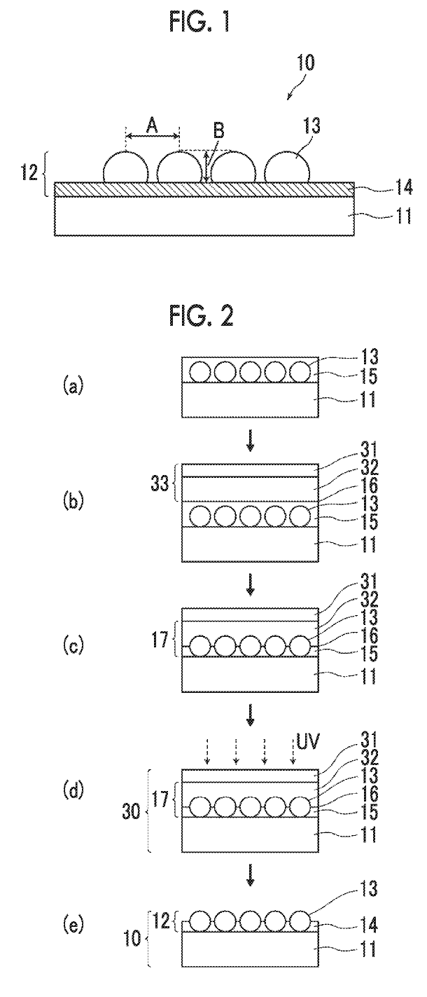

Each component of the antireflection film according to the embodiment of the present invention is described with reference to FIG. 1.

As illustrated in FIG. 1, an antireflection film 10 according to the embodiment of the present invention is obtained by laminating an antireflection layer 12 on a support 11 having a transmittance of 80% or more, in which a reflectance difference before and after the deformation in a case of outward bending or inward bending with R of 0.8 mm in biaxial directions different by 90° is within 1.0%.

The antireflection film according to the embodiment of the present invention has high bending resistance and transparency while low reflectance is maintained and can suppress fluctuation of reflectance before and after bending.

It is preferable that fine particles having a hardness of 400 MPa or more are used, since scratch resistance of the antireflection film is improved.

An embodiment of the specific configuration for realizing the antireflection film according to the embodiment of the present invention is as follows. It is preferable that the antireflection layer 12 includes a binder 14 and a fine particle 13, and has a periodic structure of equal to or less than a visible light wavelength of 380 nm which is formed by the unevenness between the binder 14 and the fine particle 13, that is, a so-called moth eye structure. It is preferable that the fine particles have an average primary particle diameter of 150 nm to 250 nm and a hardness of 400 MPa or more, and the binder includes at least one of polyacrylate or polyurethane acrylate. The elongation rate of the antireflection film is preferably 10% or more.

In the above configuration, particles having a hardness of 400 MPa or more are used as the fine particles, and thus also has excellent scratch resistance.

Here, the moth eye structure refers to a surface obtained by processing of a substance (material) for suppressing reflection of light and a structure of having a periodic microstructure pattern. Particularly, in a case of having the purpose of suppressing reflection of visible light, the moth eye structure refers to a structure having a microstructure pattern with a period of 380 nm or less. It is preferable that the period of the microstructure pattern is 380 nm or less, the tint of reflected light becomes small. Whether the moth eye structure is present can be checked by observing the surface shape with a scanning electron microscope (SEM), an atomic force microscope (AFM) or the like, and checking whether the microstructure pattern can be formed.

As illustrated in FIG. 1, the periodic structure of the antireflection layer 12 of the antireflection film according to the embodiment of the present invention is an unevenness structure formed by spreading a part of fine particles in a binder layer. The distance A between peaks of the adjacent protrusions is 380 nm or less. It is preferable that B/A which is the ratio of a distance A between peaks of adjacent protrusions and a distance B between a center between peaks of adjacent protrusions and a recessed part is 0.4 or more. In a case where B/A is 0.4 or more, the refractive index gradient layer in which the depth of the recessed part is greater than the distance between the protrusions and the refractive index gradually changes from the air to the inside of the antireflection layer can be formed, and thus the reflectance can be further reduced.

In order to suppress the occurrence of blueness, it is preferable that the fine particle for forming the protrusions is uniformly spread at an appropriate filling rate. In view of the above, the content of the fine particle for forming the protrusions is preferably adjusted such that the fine particle is uniform over the entire antireflection layer. The filling rate can be measured as the area occupation ratio (particle occupancy ratio) of the fine particle located most surface side in a case of observing the fine particle for forming the protrusions from the surface by a SEM or the like, and is 50% to 85%, preferably 55% to 80%, and more preferably 60% to 75%.

It is preferable that the surface structure of the antireflection layer 12 according to the present invention has a structure repeatedly including regions where an etching rate in a case where the surface of the antireflection layer 12 is etched with argon gas plasmatized at 13.56 MHz differs by 10 times or more, at a period of 380 nm or less. That is, as illustrated in FIG. 1, the surface of the antireflection layer constitutes a periodic structure pattern of 380 nm or less with the binder and the fine particles. Since the hardness of the fine particles having a hardness of 400 MPa or more is different from the hardness of the binder, in a case where the surface is etched under the above etching conditions, the etching rate of the binder is high, the etching rate of the fine particles is low, and the etching rates of the both are different from each other by 5 times or more. In view of improving the scratch resistance, the etching rates are different from each other more preferably 10 times or more, and even more preferably 50 times or more.

<Elongation Rate>

The antireflection film according to the embodiment of the present invention preferably has an elongation rate of 10% or more, and can be manufactured by constituting the binder and the support of the antireflection layer as below The elongation rate is 20% or more in a more preferred embodiment, 45% or more in an even more preferred embodiment, and 100% in a most preferred embodiment.

Here, with respect to the elongation rate in the present specification, in conformity with JIS K5600, the antireflection film is cut such that the length in the measurement direction is 100 mm, and the width is 10 mm, and an elongation at break in a case where the antireflection film is stretched at length between chucks of 100 mm and in a tension rate of 10%/min in an atmosphere of 25° C. and 60% RH by using a fully automatic tensile tester manufactured by INTESCO Co. Ltd. immediately after the antireflection film is left for two hours in an environment of 25° C. and 60% RH is set to an elongation rate (%).

<Reflectance>

It is preferable that the antireflection film according to the embodiment of the present invention has the reflectance of 1.3% or less, Accordingly, the antireflection function can be caused to be excellent. The reflectance is 1.1% or less in a more preferred embodiment and 0.9% or less in an even more preferred embodiment.

Here, according to the present specification, the reflectance is an integrated reflectance. The integrated reflectance is a value measured by the following method.

With respect to the antireflection film before and after washing with methyl isobutyl ketone (MIBK), in a state in which the back side (substrate side) of the film was roughened with sandpaper, an oily black ink (magic ink for supplement: Teranishi Chemical industry Co., Ltd.) was applied such that backside reflection was eliminated, an adapter ARV-474 was attached to a spectrophotometer V-550 (manufactured by JASCO Corporation), and the reflectance at an incidence angle of 5° in the wavelength range of 380 to 780 nm was measured to obtain the integrated reflectance.

<Bending Resistance and Reflectance Difference>

With respect to the antireflection film according to the present invention, a reflectance difference before and after the deformation in a case of outward bending or inward bending with R of 0.8 mm in different biaxial directions is within 1.0%. That is, with respect to the antireflection film according to the present invention, even in a case of outward bending or inward bending with R of 0.8 mm in biaxial directions different by 90°, none of the support and the antireflection layer is not cracked, and a low reflectance can be maintained, According to a more preferred embodiment, the reflectance difference can be caused to be within 0.5%.

Here, different biaxial directions mean any uniaxial direction in a film plane direction and an axial direction intersecting 90° with any uniaxial direction.

The reflectance difference is a value obtained by subtracting a reflectance before deformation from a reflectance after deformation.

“Outward bending” means a case of performing bending with the antireflection layer side facing outward, and “inward bending” means a case of performing bending with the antireflection layer facing inward.

In this case, the reflectance difference means that a difference is within 1.0% on at least one of the outward bending or the inner bending. In the case of the outward bending, it is more preferable that the reflectance difference is within 1.0%. In the outward bending, cracks easily occur since a side having the antireflection layer is bent, but with respect to the antireflection film according to the embodiment of the present invention, even in a case of outward bending in a triaxial direction of 60°, it is possible to cause the reflectance difference before and after the deformation to be within 1.0% and also within 0.5%.

<Scratch Resistance>

With respect to the antireflection film according to the embodiment of the present invention, in a scratch resistance test, the reflectance difference before and after rubbing is preferably within 0.2%, and the scratch resistance is excellent in this range. The reflectance difference is 0.2% or less in a more preferred embodiment and is within 0.1% in an even more preferred embodiment.

With respect to the scratch resistance in the present specification, steel wool of product number B-204 and a grade (count) #0000 which is manufactured by Nippon Steel Wool Co., Ltd. is wrapped around a front end section of a 1 cm square of a rubbing tester, and in a case where the surface of the antireflection layer opposite to the support is rubbed with a load of 50 g/cm², whether a reflectance difference between rubbed and non-rubbed portions is within 0.2% is determined to obtain a criterion.

<<Antireflection Layer>>

<Binder>

In order to realize an antireflection film having an elongation rate of 10% or more, at least the antireflection layer has the elongation rate of 10% or more. In a case where the antireflection layer includes the binder and the fine particle, a change in the optical film thickness of the binder in a case of being stretched most affects the reflectance of the antireflection film. The elongation rate of the binder is preferably at least 10% or more. Examples of the binder include a spacer or polyacrylate or polyurethane acrylate having a rubbery structure, and the binder may include one or the both.

A polymer having a spacer is a polymer having a spacer in a macromolecule. The spacer is a group that two-dimensionally and three-dimensionally connects molecules by a covalent bond, and an alkylene group having 2 to 12 carbon atoms, an alkylene oxide having 2 to 12 carbon atoms, or the like is preferable.

The rubber structure is a polymer having a polymerizable group in the macromolecule. By causing the polymerizable group to crosslink the macromolecules, a cured product has rubber elastic properties. For example, the polymerizable group is preferably an unsaturated polymerizable group and more preferably a vinyl group.

A commercially available product of (meth)acryloyl having a spacer or a rubbery structure is preferably BAC-45 (polybutadiene terminal diacrylate, elongation at break of 100%, manufactured by Osaka Organic Chemical Industry Ltd.), and HYDRAN UV-100A (water-soluble acrylic resin, elongation at break of 45%, manufactured by DIC Corporation).

Examples of a commercially available product of urethane (meth)acrylates include UA-122P (urethane acrylate oligomer, elongation at break of 30%, manufactured by Shin-Nakamura Chemical Co., Ltd.), UV2750B (urethane acrylate oligomer, elongation at break of 40%, manufactured by The Nippon Synthetic Chemical Industry Co., Ltd.), UV-6630B (urethane acrylate oligomer, elongation at break of 12%, manufactured by The Nippon Synthetic Chemical Industry Co., Ltd), and UV-7510 B (urethane acrylate oligomer, elongation at break of 20%, manufactured by The Nippon Synthetic Chemical Industry Co., Ltd.).

<Fine Particle>

The fine particles are preferably metal oxide particles. Examples of the metal oxide particle include a silica particle, a titanic particle, a zirconia particle, and an antimony pentoxide particle. Since the refractive index is close to many binders, haze is hardly generated and the moth eye structure is easily formed. Therefore, a silica panicle is preferable. The silica particle may be crystalline or amorphous. A shape of the fine particle is most preferably a spherical shape, but may be a shape other than a spherical shape such as an amorphous shape. The fine particle may be used singly, or two or more kinds of particles having different average primary particle diameters may be used.

In view of high hardness, calcined silica particles are particularly preferable.

The calcined silica particle can be manufactured by a well-known technique of hydrolyzing and condensing a hydrolyzable silicon compound in an organic solvent including water and a catalyst to obtain a silica particle and calcining the silica particle, and, for example, JP2003-176121A and JP2008-137854A can be referred to.

The silicon compound as a raw material for manufacturing the calcined silica particle is not particularly limited, and examples thereof include a chlorosilane compound such as tetrachlorosilane, methyltrichlorosilane, phenyltrichlorosilane, dimethyldichlorosilane, diphenyldichlorosilane, methyl vinyl dichlorosilane, trimethylchlorosilane, and methyl diphenylchlorosilane; an alkoxy silane compound such as tetramethoxy silane, tetraethoxy tetraisopropoxy silane, tetrabutoxy silane, methyltrimethoxy silane, methyltriethoxy silane, trimethoxyvinyl silane, triethoxyvinyl 3-glycidoxypropyltriethoxy 3-chloropropyltrimethoxy silane, 3-mercaptopropyltrimethoxy silane, 3-(2-aminoethylamino) propyltrimethoxy silane, phenyltrimethoxy silane, phenyltriethoxy silane, dimethyl dimethoxy silane, dimethyl diethoxy silane, 3-glycidoxypropylmethyldimethoxy silane, 3-glycidoxypropylmethyldiethoxy silane, 3-chloropropylmethyldimethoxy silane, diphenyldimethoxy silane, diphenyldiethoxy silane, dimethoxydiethoxy silane, trimethylmethoxy silane, and trimethylethoxy silane; an acyloxy silane compound such as tetraacetoxy silane, methyl triacetoxy silane, phenyl triacetoxy silane, dimethyl diacetoxy silane, diphenyl diacetoxy silane, and trimethylacetoxy silane; and a silanol compound such as dimethyl silanediol, diphenyl silanediol, and trimethylsilanol. Among the exemplary silane compounds, an alkoxysilane compound is particularly preferable, since alkoxysilane compound can be obtained more easily and halogen atoms as impurities in the obtained calcined silica particle are not included. As a preferred embodiment of the calcined silica particle according to the present invention, it is preferable that the content of halogen atoms is substantially 0%, and halogen atoms are not detected.

The calcining temperature is not particularly limited, but is preferably 800° C. to 1,300° C. and more preferably 1,000° C. to 1,200° C.,

(Hardness)

In order to cause the surface of the antireflection film to have scratch resistance, the hardness of the fine particles is preferably 400 MPa or more, more preferably 450 MPa or more, and even more preferably 550 MPa or more. It is preferable that the indentation hardness of the fine particles is 400 MPa or more, since the durability against the pressure in the thickness direction of the moth eye structure increases. In order to prevent brittleness and easy cracking, the indentation hardness of the fine particles is preferably 1,000 MPa or less.

The hardness of the fine particles means indentation hardness. The indentation hardness can be measured by a nanoindenter or the like. As a specific measurement method, the fine particles are aligned on a substrate (glass plate, quartz plate, or the like) which is harder than the fine particles such that the particles are not overlapped by one or more stages and are pushed with a diamond indenter for measurement. In this case, it is preferable to fix the particles with a resin or the like such that the particles do not move. However, in the case of fixing with the resin, adjustment is performed such that a part of the particles is exposed. Further, it is preferable that the pushing position is specified by the triboindenter.

Also in the present invention, fine particles are arranged on the substrate, a sample is manufactured by binding and fixing the particles by using a minute amount of a curable resin so as not to affect the measurement value, and the indentation hardness of the fine particles of the sample is measured by a method using an indenter.

(Average Primary Particle Diameter)

The average primary particle diameter of the fine particle is 150 nm to 250 nm. The average primary particle diameter is preferably 220 nm or less and more preferably 190 nm or less.

Here, the average primary particle diameter of the fine particle refers to the cumulative 50% particle diameter of the volume-average particle diameter. A scanning electron microscope (SEM) can be used to measure the particle diameter. A powder particle (in a case of a dispersion liquid, ones obtained by volatilizing a solvent by drying) is observed at the appropriate magnification (about 5,000 times) by SEM observation, the diameter of each of 100 primary particles is measured, the volume thereof is calculated, and the cumulative 50% particle diameter can be taken as the average primary particle diameter. In a case where the particle is not spherical, the average value of the long diameter and the short diameter is regarded as the diameter of the primary particle. In a case where the particles contained in the antireflection film are measured, it is calculated by observing the antireflection film from the front surface side by SEM in the same manner as described above. In this case, for easier observation, carbon vapor deposition, an etching treatment, and the like may be suitably applied to the sample.

As the specific examples of particles having an average primary particle diameter of 150 nm to 250 nm and a hardness of 400 MPa or more, SEAHOSTAR KEA-18 (manufactured by Nippon Shokubai Co., Ltd., Hardness of 400 MPa), SEAHOSTAR KE-S10 (average primary particle diameter of 150 nm, manufactured by Nippon Shokubai Co., Ltd., Hardness of 450 MPa), EPOSTAR S (average primary particle diameter of 200 nm, manufactured by Nippon Shokubai Co., Ltd., melamine-formaldehyde condensate), EPOSTAR MA-MX100W (average primacy particle diameter of 175 nm, manufactured by Nippon Shokubai Co., Ltd., polymethyl methacrylate (PMMA)-based crosslinked product), STAPHYLOID (multilayer structure organic fine particles manufactured by AICA Kogyo Co., Ltd.), GANZ PEARL (polymethyl methacrylate manufactured by AICA Kogyo Co., Ltd., polystyrene particles), and the like can be preferably used.

Hereinafter, each configuration of the antireflection film other than antireflection layer is specifically described.

<<Support>>

<Transmittance>

The transmittance of the support used in the antireflection film according to the embodiment of the present invention is 80% or more, The transmittance is more preferably 85% or more and even more preferably 90% or more. In a case where the transmittance is 80% or more, the transmittance of the entire display in which the antireflection film according to the embodiment of the present invention is used can be increased, and thus it is possible to design a display having high brightness and less power consumption. It is possible to increase the transmittance of the entire antireflection product in which the antireflection film according to the embodiment of the present invention is used, and thus the visibility of an inner product increases.

<Thickness of Support>

A thickness of the support is preferably 60 μm or less, more preferably 40 μm or less, and even more preferably 25 μm or less. As the thickness of the support becomes smaller, the curvature difference between the front surface and the back surface in a case of being bent becomes smaller, and thus it is preferable since cracks and the like are unlikely to occur, and breakage of the substrate does not occur even in a case where being bent is performed a plurality of times.

<Polymer Resin>

The support of the antireflection film according to the embodiment of the present invention preferably includes a polymer resin and a softening material satisfying Expression (1).

N(10)≥1.1×N(0) Expression (1)

Here, N(10) is the number of times of the bending resistance of the support including 10 parts by mass of the softening material with respect to 100 parts by mass of the polymer resin, and N(0) is the number of times of the bending resistance of the support only consisting of a polymer resin.

It is preferable that the elongation rate of the support is 20% or more. The elongation rate in this case means a value measured with the support singly by using a method of measuring the elongation rate of the antireflection film.

The support of the antireflection film according to the embodiment of the present invention may be manufactured by a single polymer resin without including the softening material, and it is desirable that the number of times of the bending resistance is great. Hereinafter, the polymer resin which is a material of the support is described.

As the polymer resin, a polymer having excellent optical transparency, excellent mechanical strength, excellent heat stability, and the like is preferable, and the number of times of the bending resistance is not particularly limited, as long as the number of times satisfies Expression (1), and any materials may be used.

Examples thereof include a polyester-based polymer such as a polycarbonate-based polymer, polyethylene terephthalate (PET), and polyethylene naphthalate (PEN), an acrylic polymer such as polymethyl methacrylate (PMMA), and polyacrylate or a polyurethane acrylate having a spacer or a rubbery structure, and a styrene-based polymer such as polystyrene and an acrylonitrile⋅styrene copolymer (AS resin), Examples thereof include polyolefin such as polyethylene and polypropylene, a polyolefin-based polymer such as a norbornene-based resin and an ethylene/propylene copolymer, an amide-based polymer such as a vinyl chloride-based polymer, nylon, and aromatic polyamide, an imide-based polymer, a sulfone-based polymer, a polyethersulfone-based polymer, a polyether ether ketone-based polymer, a polyphenylene sulfide-based polymer, a vinylidene chloride-based polymer, a vinyl alcohol-based polymer, a vinyl butyral-based polymer, an allylate-based polymer, a polyoxymethylene-based polymer, an epoxy-based polymer, a cellulose-based polymer represented by triacetyl cellulose, a copolymer of the above polymers, or a polymer obtained by mixing the above polymers.

In view of causing the elongation rate of the antireflection film to be 10% or more, polyacrylate or polyurethane acrylate having a spacer or a rubbery structure is preferable, and any one or the both may be included.

<Softening Material>

The support of the antireflection film according to the embodiment of the present invention may contain a material for softening the polymer resin. As the softening material, a rubber elastic body, a brittleness improver, a plasticizer, a slide ring polymer, or the like can be used. The softening material of the present invention increases the number of times of the bending resistance of the polymer resin such that the number of times of the bending resistance to satisfy Expression (1).

(Rubber Elastic Body)

In the present invention, in order to provide the flexibility to the antireflection film, the support may include a rubber elastic body. The rubber elastic body of the present invention is a material that is included in the definition of rubber in JIS K6200, and also refers to a material that satisfies Expression (1) in a case of being mixed with a polymer resin. Also, since the rubber elastic body has flexibility singly in the present invention, the rubber elastic body may be used as the support singly without being mixed with the polymer resin.

Specific examples of the materials of the rubber elastic body include styrene-butadiene rubber (SBR), butadiene rubber (BR), isoprene rubber (IR), isobutylene-isoprene rubber (IIR), chloroprene rubber (CR), ethylene-propylene rubber (EPM), ethylene-propylene-diene rubber (EPDM), acrylic rubber (ACM), urethane rubber (U), silicone rubber (Si, Q), fluoro rubber (FKM), nitrile rubber (NBR), synthetic natural rubber (IR), and natural rubber (NR) (abbreviated names by ASTM in parentheses). Examples thereof include styrene-based, olefin-based, ester-based, urethane-based, and amide-based thermoplastic elastomers. As long as the range satisfies Expression (1), the rubber elastic body is preferably used in the present invention in a case of being mixed with a polymer resin or the single use.

As the material of the rubber elastic body and the characteristics of the physical properties thereof, a material having a carbon-carbon double bond which does not constitute an aromatic ring, a material having a core-shell particle form, and a crosslinked or polymerized material that is defined as a rubber polymer can be preferably used.

—Rubber Elastic Body Having Carbon-Carbon Double Bond that Does Not Constitute Aromatic Ring—

A “carbon-carbon double bond that does not constitute an aromatic ring” refers to those excluding materials included in an aromatic ring from carbon-carbon double bonds. The rubber elastic body is preferably a polymer, more preferably has a carbon-carbon double bond that does not constitute an aromatic ring in a main chain, and even more preferably contains a repeating unit represented by Formula (A).

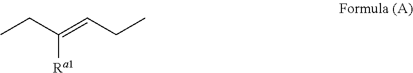

R^{a1} in Formula (A) represents a hydrogen atom or a methyl group.

R^{a1} is preferably a hydrogen atom.

According to the present invention, the rubber elastic body preferably has a carbon-carbon double bond that does not constitute an aromatic ring, and a core-shell particle or a rubber polymer may be used.

In the present invention, it is preferable to manufacture the support by using the solution casting method, but in a case where a rubber elastic body that is contained in a composition that forms a support has a carbon-carbon double bond that does not constitute an aromatic ring, the solubility and the dispersibility in the solution become excellent, such that a haze (particularly, inside haze of the film) of an obtainable film can be reduced.

(Core-Shell Particle)

A particle (core-shell particle) having a core-shell structure can be used as the rubber elastic body. The core-shell particle has alternating layers of two types (core and one shell) or three types or more (core and two or more shells) of various polymers. It is preferable that the individual layers of the core-shell particle are formed of polymers with different glass transition temperatures (Tg).

A polymer having a low glass transition temperature is called a rubber phase as a core, and a polymer having a high glass transition temperature is called a hard phase as a shell.

For example, the core-shell particle can be manufactured by emulsion polymerization. One or more layers may be chemically crosslinked in a case of manufacturing such that a shape and a size of the core-shell particle do not change during blending.

In a case where a crosslinking-type core-shell particle is used, the particle diameter does not change in a case of manufacturing a film, and thus the particle diameter of the core-shell particle existing in the support is easily controlled.

—Rubber Phase—

The uncrosslinked base material which can be used for the crosslinked rubber phase is a polymer having the glass transition temperature of preferably less than 0° C., more preferably less than −20° C., and particularly preferably less than −40° C.

The glass transition temperature of the rubber phase is not respectively measured, but can be determined by manufacturing an emulsion polymer of a corresponding monomer composition, performing isolation, and subsequently measuring the glass transition temperature. Another method of measuring the glass transition temperature of the rubber phase is to measure dynamic mechanical properties of a novel polymer blend and dynamic mechanical properties of a single matrix polymer. The maximum value of the mechanical loss factor curves can be considered as a measure of the glass transition temperature.

A rubber phase existing in the core-shell particle appropriate for the object of the present invention is 10 to 90, preferably 20 to 70, and particularly preferably 30 to 60 vol % based on the total volume of the particles.

The hard phase existing in the core-shell particle appropriate for the object of the present invention is 90 to 10, preferably 80 to 30, and particularly preferably 70 to 40 vol % based on the total volume of the particles.

The manufacturing of the core-shell particle is well-known, and details thereof are disclosed, for example, in U.S. Pat. No. 3,833,682A, U.S. Pat. No. 3,787,522A, DE116653A, DE2253689A, DE4132497A, DE4131738A, DE4040986A, U.S. Pat. No. 3,125,1904A, and DE3300526A.

The polymer that is used as the rubber phase of the core-shell particle may be a homopolymer or a copolymer formed of two or more monomers.

Homopolymers or copolymers, which can be used as the rubber phase, can be derived from the following monomers: conjugated diene monomers (for example, butadiene, isoprene, and chloroprene), monoethylenically unsaturated monomers, for example, alkyl and aryl acrylates (here, alkyl groups may be linear, cyclic, or branched, and the aryl group may have a substituent), alkyl and aryl methacrylates (here, the alkyl group is, linear, cyclic, or branched, and the aryl group may have a substituent), substituted alkyl and aryl methacrylates and acrylates (here, the substituent may be linear, cyclic, or substituted alkyl groups or substituted aryl groups), acrylonitrile and substituted acrylonitriles (for example, methacrylonitrile, α-methylene glutaronitrile, α-ethylacrylonitrile, and α-phenylacrylonitrile), alkyl- and arylacrylamides, and substituted alkyl- and arylacrylamides, vinyl esters and substituted vinyl esters, vinyl ethers and substituted vinyl ethers, vinyl amides and substituted vinyl amides, vinyl ketones and substituted vinyl ketones, halogenated vinyls, and substituted halogenated vinyls, for example, olefins having one or more double bonds that are used to manufacture olefinic rubbers, particularly, ethylene, propylene, butylenes, and 1,4-hexadiene, and vinyl aromatic compounds (for example, styrene, α-methylstyrene, vinyl toluene, halostyrenes, and tert-butyl styrenes).

A rubber phase based on organopolysiloxanes represented by Formula (I) can also be used for the manufacturing of core-shell particles.

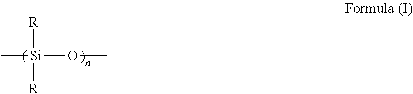

In Formula (I), R is an alkyl or alkenyl group having 1 to 10 carbon atoms, an aryl group, or a substituted hydrocarbon group. A plurality of R's may be identical to or different from each other. The above alkyl and alkenyl groups may be linear, branched, or cyclic. n represents a natural number of 2 or more.

It is also possible to use rubber phases based on fluorinated monoethylenically unsaturated compounds such as tetrafluoroethylene, vinylidene fluoride, hexafluoropropene, chlorotrifluoroethylene, and perfluoro(alkyl vinyl)ethers.

The rubber phase may be crosslinked and may be manufactured by polyfunctional unsaturated compounds as disclosed in DE1116653A, U.S. Pat. No. 3,787,522A and EP0436080A. In these publications, the use of grafting-on monomers is also disclosed. These compounds can be used to further chemically crosslink the shell to this underlying phase, as desired.

According to the present invention, in a case where a core-shell particle is used as a rubber elastic body, the rubber phase that constitutes the core is preferably formed of a compound having a carbon-carbon double bond that does not constitute an aromatic ring, and particularly, the rubber phase of the rubber elastic body is preferably a core-shell particle having a repeating unit derived from butadiene.

—Hard Phase—

The polymer that can be used in the hard phase of the core-shell particle is homopolymers or copolymers. In the present specification, the copolymers may be formed of two or more kinds of monomers. The characteristics common to the preferable homopolymer and copolymer are the glass transition temperature of 50° C. or more.

Homopolymers or copolymers, which can be used as the hard phase, can be derived from the following monomers: monoethylenically unsaturated compounds, for example, alkyl and aryl acrylates (here, alkyl groups may be linear, cyclic, or branched, and the aryl group may have a substituent), alkyl and aryl methacrylates (here, the alkyl group may be linear, cyclic, or branched, and the aryl group may have a substituent), substituted alkyl and aryl methacrylates and acrylates here, the substituent may be linear, cyclic, or substituted alkyl groups, or substituted aryl groups), acrylonitrile and substituted acrylonitriles (for example, methacrylonitrile, α-methylene glutaronitrile, α-ethylacrylonitrile, and α-phenylacrylonitrile), alkyl- and arylacrylamides, vinyl esters and substituted vinyl esters, vinyl ethers and substituted vinyl ethers, vinyl amides and substituted vinyl amides, vinyl ketones and substituted vinyl ketones, halogenated vinyls and substituted halogenated vinyls, olefins (for example, ethylene, propylene, and butylene), cyclic olefins (for example, norbornene, tetracyclododecene, and 2-vinyl norbornene), a fluorinated monoethylenically unsaturated compound, for example, tetrafluoroethylene, vinylidene fluoride, hexafluoropropene, chlorotrifluoroethylene, and perfluoro(alkyl vinyl) ethers, and a vinyl aromatic compound represented by Formula (II).

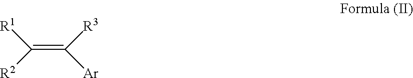

In Formula (II), R¹, R², and R³ may be identical to or different from each other, and represents hydrogen, or a linear, branched, or cyclic alkyl group or a substituted or unsubstituted aryl group, Ar represents an aromatic group (preferably an aromatic group having 6 to 18 carbon atoms) which may have an additional substituent such as alkyl or halogen groups.

The hard phase may be crosslinked and may be prepared from polyfunctional unsaturated compounds as disclosed in DE2116653A, U.S. Pat. No. 3,787,522A, and EP0436080A. In these publications, the use of grafting-on monomers is also disclosed. These compounds can be used to further chemically crosslink the shell to this underlying phase, as desired.

The polymer that is an uncrosslinked base material for a hard phase has a glass transition temperature having 50° C. or more, preferably 80° C. or more, and particularly preferably 100° C. or more.

As the rubber elastic body, a commercially available core-shell particle, for example, Staphyloid GRADE of TAKEDA Chem, Industries. disclosed in disclosed in JP00175149 and JP0129266B, Kane-Ace GRADE of KANEKA disclosed in a catalog of Knae ACE-B products, Metablen C, Metablen W, and Metablen E GRADE of METABLEN Company BV disclosed in a catalog of Metablen products, for example, page 29 and the following pages of Gachter/Muller Kunststoff-Additive [Plastics Additives], Carl Hanser, Munich (1983), or PARALOID BTA733 catalog, Impact Modifiers for Clear Packaging (1987) of Rohm and Haas, Blendex GRADE manufactured by GE PLASTICS and Paraloid GRADE manufactured by ROHM and HAAS, or PARALOID BTA-III N2 BTA-702 BTA 715 catalog (1989) of Rohm and Haas can be used.

As the form of the core-shell particles, core-shell particles (MBS) having butadiene as a core and at least one of styrene or methyl methacrylate (a styrene ratio is more preferably 10 mol % or more and even more preferably 30 mol % or more) as shells are preferably used.

In a case where the core-shell particle is used as the rubber elastic body, the content of the core-shell particle is preferably 2.5 to 50 mass %, more preferably 5 to 40 mass %, and even more preferably 10 to 25 mass % with respect to the total mass of the support. In a case where the content of the core-shell particle is 2.5 mass % or more, the adhesiveness between the support and the polarizer can be increased, and in a case where the content thereof is 50 mass % or less, the haze (particularly, the inside haze of the film) of the support is preferably small.

(Rubber Polymer)

In the present invention, the rubber polymer can be used as the rubber elastic body. The rubber polymer is a polymer having a glass transition temperature of 40° C. or less. The rubber polymer includes rubber and a thermoplastic elastomer. In a case where the glass transition temperature has two or more points as a block copolymer, in a case where the lowest glass transition temperature is 40° C. or less, the material can be used as the rubber polymer. The Mooney viscosity (ML1+4, 100° C.) of the rubber polymer is appropriately selected according to the purpose of use, but is usually 5 to 300.

Examples of the rubber polymer include diene-based rubber such as polybutadiene, polyisoprene, a random copolymer of styrene and butadiene or isoprene, an acrylonitrile-butadiene copolymer, a butadiene-isoprene copolymer, a butadiene-(meth)acrylic acid alkyl ester copolymer, a butadiene-(meth)acrylic acid alkyl ester-acrylonitrile copolymer, and a butadiene-(meth)acrylic acid alkyl ester-acrylonitrile-styrene copolymer; a butylene-isoprene copolymer; an aromatic vinyl-conjugated diene-based block copolymer such as a styrene-butadiene block copolymer, a hydrogenated styrene-butadiene block copolymer, a hydrogenated styrene-butadiene random copolymer, a styrene-isoprene block copolymer, and a hydrogenated styrene-isoprene block copolymer; and a low crystalline poly butadiene resin.

As the rubber polymer, a styrene-butadiene-styrene block copolymer (SBS) is preferably used.

The particle diameter of the rubber elastic body is preferably 10 nm to 500 nm, more preferably 50 nm to 300 nm, and even more preferably 50 nm to 100 nm.

In a case where the particle diameter of the rubber elastic body is 10 nm or more, the adhesiveness between the film and the polarizer is excellent, and in a case where the particle diameter thereof is 500 nm or less, the haze of the film, particularly, the inside haze of the film is low.

The weight-average molecular weight of the rubber elastic body is preferably 50,000 to 200,000, more preferably 50,000 to 150,000, and even more preferably 50,000 to 100,000. In a case where the weight-average molecular weight of the rubber elastic body is 50,000 or more, the close attachment between polarizers is excellent, and in a case where the weight-average molecular weight thereof is 200,000 or less, the haze is small.

(Brittleness Improver)

According to the present invention, the brittleness improver may be provided in the support in order to provide the flexibility to the antireflection film. Examples of the brittleness improver include the following compounds.

The brittleness improver of the present invention is preferably a compound having a repeating unit. Examples of the compound having a repeating unit include a condensate or an adduct, the condensate is preferably a condensate of polyhydric alcohol and polybasic acid, a condensate of polyhydric ether alcohol and polybasic acid, and a condensate of a condensate of polyhydric alcohol and polybasic acid and an isocyanate compound, and the adduct is preferably an adduct of acrylic acid ester and an adduct of methacrylic acid ester. At least one compound having a number-average molecular weight of 600 or more which is selected from a poly ether-based compound, a polyurethane-based compound, a polyether polyurethane-based compound, a polyamide-based compound, a polysulfone-based compound, a polysulfonamide-based compound, or other polymer-based compounds described below.

At least one thereof is preferably a condensate of polyhydric alcohol and polybasic acid, a condensate of polyhydric ether alcohol and polybasic acid, an adduct of acrylic acid ester, and an adduct of methacrylic acid ester, more preferably a condensate of polyhydric alcohol and polybasic acid and an adduct of acrylic acid ester, and even more preferably a condensate of polyhydric alcohol and polybasic acid.

Hereinafter, condensates of polyhydric alcohol and polybasic acid and adducts of acrylic acid ester which are compounds having a repeating unit preferably used in the present invention.

(1) Condensate Between Polyhydric Alcohol and Polybasic Acid

The condensate between polyhydric alcohol and polybasic acid is described below. The preferable condensate of polyhydric alcohol and polybasic acid is not particularly limited, and a condensate obtained by reaction of dicarboxylic acid and glycol is preferable. Both terminals of the reactant obtained by the reaction of dicarboxylic acid and glycol may be left as reactants, but it is preferable that so-called sealing of terminals is performed by further reacting monocarboxylic acid or monoalcohol, since the retardation change in a case of being maintained in a wet heat environment can be suppressed. In such a condensate, the hydroxyl number of the terminal is decreased compared with the unsealed condensate, and the hydroxyl number is preferably 40 mgKOH/g or less, more preferably 20 mgKOH/g or less, and even more preferably 10 mgKOH/g or less. The condensate of polyhydric alcohol and polybasic acid which is used in the present invention is preferably synthesized with glycol having 3 to 12 carbon atoms and dicarboxylic acid having 5 to 12 carbon atoms.

With respect to the antireflection film according to the embodiment of the present invention, dicarboxylic acid that is used in a condensate of polyhydric alcohol and polybasic acid is preferably an aliphatic dicarboxylic acid residue or alicyclic dicarboxylic acid residue having 5 to 12 carbon atoms or an aromatic dicarboxylic acid residue having 8 to 12 carbon atoms. The glycol is preferably an aliphatic or alicyclic glycol residue having 3 to 12 carbon atoms or an aromatic glycol residue having 6 to 12 carbon atoms.

Hereinafter, the dicarboxylic acid and the glycol that can be preferably used in the synthesis of condensate between polyhydric alcohol and polybasic acid is described.

As the dicarboxylic acid, both of an aliphatic dicarboxylic acid and an aromatic dicarboxylic acid can be used.

Examples of the aliphatic dicarboxylic acid include oxalic acid, malonic acid, succinic acid, maleic acid, fumaric acid, glutaric acid, adipic acid, suberic acid, azelaic acid, cyclohexanedicarboxylic acid, sebacic acid, and dodecanedicarboxylic acid. Among these, it is preferable to include adipic acid, suberic acid, azelaic acid, and sebacic acid in view of improving brittleness.

Examples of the aromatic dicarboxylic acid include phthalic acid, terephthalic acid, isophthalic acid, 1,5-naphthalenedicarboxylic acid, and 1,4-naphthalenedicarboxylic acid. Among these, phthalic acid and terephthalic acid are preferable, and terephthalic acid is particularly preferable.

The number of carbons in the dicarboxylic acid used in the present invention is preferably 5 to 12, more preferably 6 to 10, and particularly preferably 6 to 8. According to the present invention, a mixture of two or more kinds of dicarboxylic acid may be used, and in this case, an average number of carbon atoms of the two or more kinds of dicarboxylic acid is preferably in the above range.

It is also preferable to use aliphatic dicarboxylic acid and aromatic dicarboxylic acid in combination. Specifically, a combination of adipic acid and phthalic acid, a combination of adipic acid and terephthalic acid, a combination of succinic acid and phthalic acid, and a combination of succinic acid and terephthalic acid are preferable, and a combination of succinic acid and phthalic acid and a combination of succinic acid and terephthalic acid are preferable. In a case where aliphatic dicarboxylic acid and aromatic dicarboxylic acid are used in combination, the ratio (molar ratio) of the both is not particularly limited but is preferably 95:5 to 40:60 and more preferably 55:45 to 45:55.

Examples of the glycol(diol) used for the condensate of polyhydric alcohol and polybasic acid include aliphatic diol and aromatic diol, and aliphatic diol is preferable.

Examples of the aliphatic diol include alkyl diol or alicyclic diol, and examples thereof include ethylene glycol (ethanediol), 1,2-propanediol, 1,3-propanediol, 1,2-butanediol, 1,3-butanediol, 2-methyl-1,3-propanediol 1,4-butanediol, 1,5-pentanediol, 2,2-dimethyl-1,3-propanediol (neopentyl glycol), 2,2-diethyl-1,3-propanediol (3,3-dimethylol-pentane), 2-n-butyl-2-ethyl-1,3-propanediol (3,3-dimethylolheptane) 3-methyl-1,5-pentanediol, 1,6-hexanediol, 1,4-cyclohexanediol, 1,4-cyclohexanedimethanol, 2,2,4-trimethyl-1,3-pentanediol, 2-ethyl-1,3-hexanediol, 2-methyl-1,8-octanediol, 1,9-nonanediol, 1,10-decanediol, and diethylene glycol.

The aliphatic diol is preferably at least one of 1,4-butanediol, 1,5-pentanediol, or 1,6-hexanediol and particularly preferably at least one of 1,4-butanediol or 1,2-propanediol. In a case where two kinds thereof are used, it is preferable to use ethylene glycol and 1,5-pentanediol.

The number of carbons in the glycol is preferably 3 to 12, more preferably 4 to 10, and particularly preferably 4 to 8. In a case where two or more kinds of glycol are used, it is preferable that an average carbon number of the above two or more kinds is in the above range.

It is preferable to protect both terminals of a condensate of polyhydric alcohol and polybasic acid with a monoalcohol residue or a monocarboxylic acid residue.

In this case, a monoalcohol residue is preferably a substituted or unsubstituted monoalcohol residue having 1 to 30 carbon atoms, and examples thereof include aliphatic alcohol such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodeca octanol, allyl alcohol, and oleyl alcohol, and substituted alcohol such as benzyl alcohol and 3-phenylpropanol.

In a case of performing sealing with a monocarboxylic acid residue, monocarboxylic acid used as the monocarboxylic acid residue is preferably a substituted or unsubstituted monocarboxylic acid having 1 to 30 carbon atoms. These may be aliphatic monocarboxylic acid or aromatic carboxylic acid. Preferable examples of the aliphatic monocarboxylic acid includes acetic acid, propionic acid, butanoic acid, caprylic acid, caproic acid, decanoic acid, dodecanoic acid, stearic acid, and oleic acid, and examples of the aromatic monocarboxylic acid include benzoic acid, p-tert-butylbenzoic acid, orthotoluic acid, meta-toluic acid, p-toluic acid, dimethylbenzoic acid, ethylbenzoic acid, normal propylbenzoic acid, aminobenzoic acid, and acetoxybenzoic acid, and these can be used singly or as a mixture of two or more kinds thereof.

In this case, in a case where the number of carbon atoms of the monocarboxylic acid residues at both terminals is 3 or less, the volatility decreases, the weight loss due to heating of the condensate of the polyhydric alcohol and the polybasic acid does not increase, and occurrence of process contamination and planar failure can be reduced. In this point of view, aliphatic monocarboxylic acid is preferable as monocarboxylic acids used for sealing. The monocarboxylic acid is more preferably an aliphatic monocarboxylic acid having 2 to 22 carbon atoms, even more preferably an aliphatic monocarboxylic acid having 2 to 3 carbon atoms, and particularly preferably an aliphatic monocarboxylic acid residue having 2 carbon atoms. For example, acetic acid, propionic acid, butanoic acid, benzoic acid, and derivatives thereof are preferable, acetic acid or propionic acid is more preferable, and acetic acid (a terminal is an acetyl group) is most preferable. Two or more monocarboxylic acids used for sealing may be mixed.

In a case where both terminals of the condensate of polyhydric alcohol and polybasic acid are unsealed, the condensate is preferably polyester polyol.

Specific examples of the preferable condensate of polyhydric alcohol and polybasic acid include poly(ethylene glycol/adipic acid) ester, poly(propylene glycol/adipic acid) ester, poly(1,3-butanediol/adipic acid) ester, poly(propylene glycol/sebacic acid) ester, poly(1,3-butanediol/sebacic acid) ester, poly(1,6-hexanediol/adipic acid) ester, poly(propylene glycol/phthalic acid) ester, poly(1,3-butanediol/phthalic acid) ester, poly(propylene glycol/terephthalic acid) ester, poly(propylene glycol/1,5-naphthalene-dicarboxylic acid) ester, a condensate in which both terminals of poly(propylene glycol/terephthalic acid) ester are 2-ethyl-hexyl alcohol ester and both terminals of poly(propylene glycol/adipic acid) ester are 2-ethyl-hexyl alcohol ester, and acetylated poly(butanediol/adipic acid) ester.

The condensate of polyhydric alcohol and polybasic acid can be easily synthesized by a common method or by any method of a thermal melt condensation method by the (poly)esterification reaction or the transesterification reaction of dibasic acid or alkyl esters thereof and glycols, or by an interface condensation method of acid chloride of these acids and glycols. The condensate of polyhydric alcohol and polybasic acid is specifically disclosed in “Plasticizer Theory and Application” (Saiwai Shobo, first edition published on Mar. 1, 1973) edited by Koichi Murai. Materials disclosed in publications of JP1993-155809A (JP-H05-155809A), JP1993-155810A (JP-H05-155810A), JP1993-197073A (JP-H05-197073A), JP2006-259494A, JP1995-330670A (JP-H07-330670A), JP2006-342227A, and JP2007-003679A can be used.

As products, as a condensate of polyhydric alcohol and polybasic acid, ADEKA CIZER (various kinds thereof such as ADEKA CIZER P series and ADEKA CIZER PN series) disclosed in page 55 to 27 of DIARY 2007, from ADEKA Co., Ltd. can be used, and various products of POLYLITE disclosed in page 25 of “Polymer Related Product List 2007” of DIC Corporation and various kinds of POLYCIZER disclosed in pages 2 to 5 of “DIC Polymer Modifier” (2004.4.1.000 VIII issue) of DIC Corporation can be used. The condensate can also be obtained as Plasthall P series manufactured by The HallStar Company, USA. Benzoyl functionalized polyethers are commercially available under the trade name BENZOFLEX from Velsicol Chemical LLC. of Rosemont, Ill. (for example, BENZOFLEX 400, polypropylene glycol dibenzoate).

(2) Adduct of Acrylic Acid Ester

The composition of the adduct of the acrylic acid ester preferably includes an aliphatic acrylic acid ester monomer, an acrylic acid ester monomer having an aromatic ring, or an acrylic acid ester monomer having a cyclohexyl group as a main component and more preferably an aliphatic acrylic acid ester monomer as a main component. The main component means that the constituent mass ratio in the (co)polymer is higher than that of the other copolymerizable component.

The constituent mass ratio of these components is preferably 40 to 100 mass %, more preferably 60 to 100 mass %, and most preferably 70 to 100 mass %.

Examples of the aliphatic acrylic acid ester monomer include methyl acrylate, ethyl acrylate, propyl acrylate (i-, n-), butyl acrylate (n-, s-, t-), pentyl acrylate (n-, s-), hexyl acrylate (n-, i-), heptyl acrylate (n-, i-), octyl acrylate (n-, i-), nonyl acrylate (n-, i-), myristyl acrylate (n-, i-), lauryl acrylate, (2-ethylhexyl) acrylate, (ε-caprolactone) acrylate, (2-hydroxyethyl) acrylate, (2-hydroxypropyl) acrylate, (3-hydroxypropyl) acrylate, (4-hydroxybutyl) acrylate, (2-hydroxybutyl) acrylate, (2-methoxyethyl) acrylate, (2-ethoxyethyl) acrylate, and (2-ethylhexyl) acrylate. Butyl acrylate and (2-ethylhexyl) acrylate are preferable.

Examples of the acrylic ester monomer having an aromatic ring include phenyl acrylate, (2 or 4-chlorophenyl) acrylate, (2 or 3 or 4-ethoxycarbonylphenyl) acrylate, (o or m or p-tolyl) acrylate, benzyl acrylate, phenethyl acrylate, and (2-naphthyl) acrylate, and benzyl acrylate and phenethyl acrylate can be preferably used.

Examples of the acrylic acid ester monomer having a cyclohexyl group include cyclohexyl acrylate, (4-methylcyclohexyl) acrylate, and (4-ethylcyclohexyl) acrylate, and cyclohexyl acrylate can be preferably used.

In addition to the above monomers, examples of the copolymerizable component include α,β-unsaturated acid such as acrylic acid and methacrylic acid, an unsaturated group-containing divalent carboxylic acid such as maleic acid, fumaric acid, and itaconic acid, an aromatic vinyl compound such as styrene and α-methylstyrene, α,β-unsaturated nitrile such as acrylonitrile and methacrylonitrile, maleic acid anhydride, maleimide, N-substituted maleimide, and glutaric acid anhydride, and these can be used singly or two or more monomers may be used in combination as a copolymerization component.

In order to synthesize an acrylic acid ester adduct having a weight-average molecular weight of 10,000 or less, it is difficult to control the molecular weight by common polymerization. Examples of the method for polymerizing a polymer having a low molecular weight include a method using a peroxide polymerization initiator such as cumene peroxide or t-butyl hydroperoxide, a method of using a polymerization initiator in a larger amount than the common polymerization, a method of using a chain transfer agent such as a mercapto compound or carbon tetrachloride in addition to the polymerization initiator, a method of using a polymerization terminator such as benzoquinone or dinitrobenzene in addition to the polymerization initiator, a method of performing bulk polymerization with a compound having one thiol group and a secondary hydroxyl group or a polymerization catalyst obtained by using the compound and an organometallic compound in combination, as disclosed in JP2000-128911A or JP2000-344823A, all of the methods are preferably used in the present invention, and the method described in the above publication is particularly preferable.

These brittleness improvers such as a condensate of polyhydric alcohol and polybasic acid and an adduct of acrylic acid ester may be used singly or two or more kinds thereof may be mixed to be used.

The weight-average molecular weight (Mw) of the brittleness improver used in the present invention is preferably 500 to 5,000, more preferably 700 to 4,000, and even more preferably 800 to 3,000. In a case where the molecular weight is 500 or more, the volatility from the film during film formation or after film formation is unlikely to cause a problem, and in a case where the molecular weight is 5,000 or less, compatibility with the polymer resin used in the present invention becomes satisfactory, such that transparency can be maintained.

(Plasticizer)

According to the present invention, in order to provide flexibility to the antireflection film, a plasticizer can be used in the substrate.

Preferable plasticizers added include low molecular weight to oligomer compounds having a molecular weight of about 190 to 5,000 within the above ranges of physical properties, and for example, phosphoric acid ester, carboxylic acid ester, and polyol esters are used.

Examples of phosphoric acid esters include triphenyl phosphate (TPP), tricresyl phosphate, cresyl diphenyl phosphate, octyl diphenyl phosphate, biphenyl diphenyl phosphate, trioctyl phosphate, and tributyl phosphate. Triphenyl phosphate and biphenyl diphenyl phosphate are preferable.

Representative examples of carboxylic acid esters include phthalic acid ester and citric acid ester. Examples of phthalic acid ester include dimethyl phthalate, diethyl phthalate, dibutyl phthalate, dioctyl phthalate, diphenyl phthalate, and diethyl hexyl phthalate. Examples of citric acid ester include triethyl O-acetyl citrate, tributyl O-acetyl citrate, acetyl triethyl citrate, and acetyl tributyl citrate.

These preferable plasticizers are liquid at 25° C. except TPP (melting point: about 50° C.) and have a boiling point of 250° C. or more.

Examples of other carboxylic acid ester include butyl oleate, methyl acetyl ricinoleate, dibutyl sebacate, and various trimellitic acid esters. Examples of glycolic acid ester include triacetin, tributyrin, butyl phthalyl butyl glycolate, ethyl phthalyl ethyl glycolate, methyl phthalyl ethyl glycolate, butyl phthalyl butyl glycolate, methyl phthalyl methyl glycolate, propyl phthalyl propyl glycolate, butyl phthalyl butyl glycolate, and octyl phthalyl octyl glycolate.

Plasticizers disclosed in JP1993-194788A (JP-H05-194788A), JP1985-250053A (JP-S60-250053A), JP1992-227941A (JP-H04-227941A), JP1994-016869A (JP-H06-016869A), JP1993-271471A (JP-H05-271471A), JP1995-286068A (JP-H07-286068A), JP1993-005047A (JP-H05-005047A), JP1999-080381A (JP-H11-080381A), JP1995-020317A (JP-H07-020317A), JP1996-057879A (JP-H08-057879A), JP1998-152568A (JP-H10-152568A), and JP1998-120824A (JP-H10-120824A) are preferably used. According to these publications, many preferable descriptions about not only exemplifications of plasticizers but also use methods thereof or characteristics thereof are provided, and those are also preferably used in the present invention.

As other plasticizers, (di)pentaerythritol esters disclosed in JP1999-124445A (JP-H11-124445A), glycerol esters disclosed in JP1999-246704A (JP-H11-246704A), diglycerol esters disclosed in JP2000-063560A, citric acid esters disclosed in JP 1999-092574A (JP-H11-092574A), substituted phenyl phosphoric acid esters disclosed in JP1999-090946A (JP-H11-090946A), and ester compounds containing an aromatic ring and a cyclohexane ring disclosed in JP2003-165868A are preferably used.

A macromolecule plasticizer having a resin component having a molecular weight of 1,000 to 100,000 is preferably used. Examples thereof include polyester and/or polyether disclosed in JP2002-022956A, polyester ether, polyester urethane, or polyester disclosed in (JP1993-197073A (JP-H05-197073A), copolyester ether disclosed in JP1990-292342A (JP-H02-292342A), and an epoxy resin or a novolak resin disclosed in JP2002-146044A.

As a plasticizer excellent in terms of volatilization resistance, bleed out, low haze, and the like, for example, it is preferable to use polyester diol having hydroxyl groups at both terminals disclosed in JP2009-098674A. As a plasticizer excellent in terms of leveling and low haze of the antireflection film according to the embodiment of the present invention, a sugar ester derivative disclosed in WO2009/031464A is also preferable.

The plasticizers may be used singly or two or more kinds thereof may be mixed to be used.

(Slide Ring Polymer)

In the present invention, a slide ring polymer can also be desirably used in order to provide flexibility to the antireflection film.

The above softening material may be mixed with the polymer resin singly, or a plurality thereof may be appropriately used in combination and mixed, and a softening material may be used singly or a plurality thereof may be used in combination without being mixed with the resin, so as to obtain a transparent support.

The amounts of mixing these softening materials are not particularly limited, as long as Expression (1) is satisfied in a case where 10 parts by mass of softening materials with respect to 100 parts by mass of the polymer resin are mixed. That is, a single polymer resin having a sufficient number of times of the bending resistance may be used as a support for the antireflection film singly, a softening material may be mixed within a range that satisfies Expression (1), and all are used as the softening material (100%), so as to have a sufficient number of times of bending resistance.

<Other Additives>

Various additives (for example, an ultraviolet absorbing agent, a matte agent, an antioxidant, a peeling accelerator, a retardation (optical anisotropy) adjusting agent, and the like) according to the application can be added to the support in each preparation step. These may be solid or oily. That is, the melting point or boiling point thereof is not particularly limited. The timing of adding the additives may be any point in the step of manufacturing the support, and a step of adding additives for preparation may be added to the material preparation step. Furthermore, the addition amount of each material is not particularly limited as long as the function is exhibited.

Hereinafter, each additive is described.

(Ultraviolet Absorbing Agent)

Examples of the ultraviolet absorbing agent include benzotriazole-based, 2-hydroxybenzophenone-based, and salicylic acid phenyl ester-based ultraviolet absorbing agents. Examples thereof include triazoles such as 2-(5-methyl-2-hydroxyphenyl) benzotriazole, 2-[2-hydroxy-3,5-bis(α,α-dimethylbenzyl)phenyl]-2H-benzotriazole, and 2-(3,5-di-t-butyl-2-hydroxyphenyl)benzotriazole, and benzophenones such as 2-hydroxy-4-methoxybenzophenone, 2-hydroxy-4-octoxybenzophenone, and 2,2′-dihydroxy-4-methoxybenzophenone.

(Matte Agent)

It is preferable that the support contains a matte agent, in view of film slipping property and stable manufacturing. The matte agent may be a matte agent of an inorganic compound or a matte agent of an organic compound.

As preferable specific examples of the matte agent of the inorganic compound, an inorganic compound including silicon (for example, silicon dioxide, calcined calcium silicate, hydrated calcium silicate, aluminum silicate, and magnesium silicate), titanium oxide, zinc oxide, aluminum oxide, barium oxide, zirconium oxide, strontium oxide, antimony oxide, tin oxide, tin oxide⋅antimony, calcium carbonate, talc, clay, calcined kaolin, and calcium phosphate are preferable, an inorganic compound including silicon or zirconium oxide is more preferable. However, since the turbidity of the cellulose acylate film can be reduced, silicon dioxide is particularly preferably used. As the fine particles of silicon dioxide, for example, commercially available products under the trade name such as AEROSIL R972, R974, R812, 200, 300, R202, OX50, and TT600 (above are manufactured by Nippon Aerosil Co., Ltd.) can be used. As the fine particles of zirconium oxide, for example, commercially available products under the trade name such as AEROSIL R976 and R811 (above are manufactured by Nippon Aerosil Co., Ltd.) can be used.

As preferable specific examples of the matte agent of the organic compound, for example, a silicone resin and an acrylic resin are preferable. Among the silicone resins, those having a three-dimensional network structure are particularly preferable, and for example, commercially available products under the trade name such as TOSPEARL 103, TOSPEARL 105, TOSPEARL 108, TOSPEARL 120, TOSPEARL 145, TOSPEARL 3120, and TOSPEARL 240 (all manufactured by Momentive Performance Materials Japan LLC) can be used.

In a case where these matte agents are added to the polymer resin solution, the method is not particularly limited thereto, and any method can be used as long as a desired polymer resin solution can be obtained. For example, additives may be contained at the stage of mixing the polymer resin and the solvent, or additives may be added after preparing the mixed solution with the polymer resin and the solvent. Further, additives may be added and mixed immediately before the casting of the dope, which is a so-called immediate addition method, and the mixture is used by installing the screw type kneading on line. Specifically, a static mixer such as an in-line mixer is preferable, and as the in-line mixer, for example, a static mixer SWJ (Toray static in-line mixer Hi-Mixer) (manufactured by Toray Engineering Co., Ltd.) or the like is preferable. With respect to the in-line addition, in order to eliminate concentration unevenness, particle aggregation, and the like, JP2003-053752A discloses, for example, an invention of removing the concentration unevenness and the aggregation of mat particles and the like, by causing a distance L between the tip of the addition nozzle that mixes an additive solution in a different composition to a main raw material dope and a starting end of the in-line mixer to be five times or less of an inner diameter d of the main material pipe, in the method of manufacturing a cyclic olefin-based resin film. As an even more preferable aspect, a distance L between a tip opening of a nozzle that supplies an additive solution in a different composition to the main raw material dope and a starting end of the in-line mixer is caused to be 10 times or less of the inner diameter (d) of a supply nozzle tip opening, such that the in-line mixer is a static non-stirring in-tube mixer or a dynamic stirring in-tube mixer. As a more specific example, it is disclosed that a flow ratio of the cellulose acylate film main raw material dope/in-line addition solution is 10/1 to 500/1 and preferably 50/1 to 200/1. JP2003-014933A having an object of a phase difference film having less additive bleed-out, no peeling phenomenon between layers, excellent slidability, and excellent transparency discloses, as a method of adding additives, additives may be added in a dissolving tank, or additives or a solution in which additives are dissolved or dispersed may be added to the dope in the liquid feeding, between the dissolving tank and the co-casting die, but, in the latter case, it is preferable to provide mixing means such as a static mixer in order to increase the mixing properties.

(Antioxidant)

As the antioxidant, compounds which prevent oxidation, deterioration, thermal decomposition, or thermal coloration in a case of forming or using a polymer resin used for a support in a film can be suitably added. An effect can be expected by adding an appropriate antioxidant to each of them by an action mechanism for trapping or decomposing alkyl radical or peroxide radical generated by oxidation of the resin. For example, IRGANOX-1010 and IRGANOX-1076 manufactured by BASF SE and SUMILIZER GM, SUMILIZER GS manufactured by Sumitomo Chemical Co., Ltd. and the like can be exemplified.

(Peeling Accelerator)

A peeling accelerator can be added in order to reduce peeling resistance in a case of peeling off from the film forming substrate. As a preferable peeling accelerator, a phosphoric acid ester-based surfactant, a carboxylic acid or a carboxylic acid salt-based surfactant, a sulfonic acid or sulfonic acid salt-based surfactant, and a sulfonic acid ester-based surfactant are effective. A fluorine-based surfactant in which a part of hydrogen atoms bonded to the hydrocarbon chain of the above surfactant is substituted with a fluorine atom is also effective. As a specific example, compounds disclosed in paragraphs <0124> to <0138> of JP2012-181516A (organic acids) can be referred to.

The addition amount of the peeling accelerator is preferably 0.05 to 5 mass %, more preferably 0.1 to 2 mass %, and most preferably 0.1 to 0.5 mass % with respect to the total amount of the polymer.

(Retardation Adjusting Agent)

A retardation adjusting agent may be added to the support. As the retardation adjusting agent, both of the retardation adjusting agent that exhibits retardation or the retardation adjusting agent that reduces retardation can be preferably used.

The additives may be used singly or two or more kinds thereof may be used in combination.

In view of the transparency, with respect to the support, it is preferable that the refractive index difference between the flexible material used for the support or various additives and the polymer resin is small.

<<Hard Coat Layer>>

The antireflection film according to the embodiment of the present invention may have a hard coat layer between the support and the antireflection layer. The hard coat layer is preferably formed by a crosslinking reaction or a polymerization reaction of a curable compound (preferably an ionizing radiation curable compound) which is a compound having a polymerizable group. For example, the hard coat layer can be formed by coating the substrate with a coating composition including an ionizing radiation curable polyfunctional monomer or a polyfunctional oligomer and subjecting the polyfunctional monomer or the polyfunctional oligomer to crosslinking reaction or polymerization reaction.

As the functional group (polymerizable group) of the ionizing radiation curable polyfunctional monomer or polyfunctional oligomer, those having light, electron beams, or radiation polymerizability are preferable. Among them, the photopolymerizable functional group is preferable.

Examples of the photopolymerizable functional group include unsaturated polymerizable functional groups such as a (meth)acryloyl group, a vinyl group, a styryl group, and an allyl group. Among them, a (meth)acryloyl group is preferable.

Specifically, a compound which is the same as the binder can be used. Accordingly, it is possible to improve the bending resistance of the hard coat layer. In view of providing the bending resistance, the elongation rate of the hard coat layer is preferably 10% or more, more preferably 20% or more, even more preferably 40% or more, and still even more preferably 100%.

In view of providing sufficient bending resistance to the film, the thickness of the hard coat layer is preferably 10 μm or less and more preferably 5 μm or less.

The strength of the hard coat layer is preferably H or more and more preferably 2H or more in a pencil hardness test. Further, in the Taber test according to JIS K5400, it is more preferable in a case where an abrasion amount of a test piece before and after the test is smaller.

[Method of Manufacturing Laminate]

The laminate in a method of manufacturing a laminate according to the embodiment of the present invention is to obtain an antireflection film. FIG. 2 is a schematic cross-sectional view of a method of manufacturing a laminate according to an embodiment.

The method of manufacturing a laminate according to the embodiment of the present invention includes a first step of coating the support 11 with a curable composition including a curable compound 12 and the line particle 13 having an average primary particle diameter of 150 nm to 250 nm and a hardness of 400 MPa, to provide a first layer 15 including a curable compound in a thickness d in which the fine particle 13 is buried in the first layer 15 as illustrated in (a) of FIG. 2,

a second step of bonding a pressure sensitive adhesive layer 32 of a pressure sensitive adhesive film 33 having a substrate 31 and the pressure sensitive adhesive layer 32 provided on the substrate 31 to an interface 16 of the first layer 15 opposite to the support 11 as illustrated in (b) of FIG. 2,

a third step of burying the fine particle 13 in a layer 17 obtained by combining the first layer 15 and the pressure sensitive adhesive layer 32 and lowering a position of the interface 16 to the support 11 side such that the fine particle 13 protrudes from the interface 16 between the first layer 15 and the pressure sensitive adhesive layer 32 as illustrated in (c) of FIG. 2, and

a fourth step of curing the first layer 15 in a state in which the fine particle 13 is buried in the layer 17 obtained by combining the first layer 15 and the pressure sensitive adhesive layer 32 as illustrated in (d) of FIG. 2 in this order.

A laminate 30 manufactured in this manner is formed of the antireflection film 10 and the pressure sensitive adhesive film 33. The antireflection film 10 having an elongation rate of 10% or more is obtained by peeling off the pressure sensitive adhesive film 33 (a fifth step described below).

According to the present invention, the pressure sensitive adhesive film and the first layer are bonded to each other in the second step, the fine particle is buried in the layer 17 obtained by combining the first layer and the pressure sensitive adhesive layer 32 in a third step described below, so as to protrude from the interface opposite to the interface of the first layer on the substrate side, the first layer is cured in a state in which the fine particle is buried in the layer 17 obtained by combining the first layer 15 and the pressure sensitive adhesive layer 32 to each other in the fourth step described below, and the aggregation is suppressed by causing the fine particle not to expose to the air interface before curing the first layer, such that a satisfactory uneven shape is formed by the fine particles.

It is possible to manufacture an antireflection film by peeling off the pressure sensitive adhesive film after the laminate of the present invention is manufactured.

<<First Step>>

The first step is a step of providing a curable compound and a fine particle having an average primary particle diameter of 150 nm to 250 nm on a support, in a thickness in which the fine particle including the curable compound is buried in the first layer.

According to the present invention, a “thickness in which the fine particle is buried in a layer including a curable compound” refers to a thickness of 0.8 times or more of the average primary particle diameter of the fine particle.

Details of the support are the same as the detail descriptions of the antireflection film, and thus the description thereof is omitted.

In the first step, the method of providing the first layer to the support is not particularly limited, but it is preferable that the first layer is provided by coating the support. In this case, the first layer is a layer obtained by applying the composition including the curable compound and the fine particle having an average primary particle diameter of 150 nm to 250 nm. The coating method is not particularly limited, and well-known methods can be used. Examples thereof include a dip coating method, an air knife coating method, a curtain coating method, a roller coating method, a wire bar coating method, a gravure coating method, and a die coating method.

In the first step, it is preferable that a plurality of fine particles are not present in a direction orthogonal to the surface of the support. Here, the expression “the plurality of fine particles are not present in the direction orthogonal to the surface of the support” indicates that, in a case where 10 μm×10 μm of the in-plane of the support is observed with three visual fields with a scanning electron microscope (SEM), the proportion of the number of fine particles in a state in which a plurality of the fine particles are not present in the direction orthogonal to the surface is 80% or more and preferably 95% or more.

<Composition for Forming First Layer>

The first layer is obtained by applying the curable composition including the curable compound and the fine particle. The first layer may contain a component in addition to the curable compound and the fine particles, and examples thereof include a solvent, a polymerization initiator, a dispersing agent of the particle, a leveling agent, and an antifouling agent.

The curable compound in the composition for forming the first layer is the same as polyacrylate or polyurethane acrylate used in the binder, which is described in the configuration of the antireflection film. The fine particle is the fine particle described in the configuration of the antireflection film.

—Solvent—

In view of improving the dispersibility, it is preferable to select a solvent having a polarity close to that of the fine particle. Specifically, for example, in a case where the fine particle is a metal oxide particle, an alcohol-based solvent is preferable, and examples thereof include methanol, ethanol, 2-propanol, 1-propanol, and butanol. For example, in a case where the fine particles is a metal resin particle subjected to hydrophobic surface modification, ketone-based, ester-based, carbonate-based, alkane, aromatic solvents, and the like are preferable, and examples thereof include methyl ethyl ketone (MEK), dimethyl carbonate, methyl acetate, acetone, methylene chloride, and cyclohexanone. A plurality of these solvents may be mixed to be used in the range that the dispersibility does not remarkably deteriorate.

—Dispersing Agent of Fine Particle—

The dispersing agent of the fine particle lowers the cohesive force between the particles such that the fine particles can be easily arranged in a uniform manner. The dispersing agent is not particularly limited, but an anionic compound such as sulfuric acid salt and phosphoric acid salt, a cationic compound such as aliphatic amine salt and quaternary ammonium salt, a nonionic compound, and a polymer compound are preferable, and a polymer compound is more preferable since the polymer compound has a high degree of freedom in selecting adsorptive groups and steric repulsive groups. As the dispersing agent, a commercially available product can be used. Examples thereof include DISPERBYK160, DISPERBYK161, DISPERBYK162, DISPERBYK163, DISPERBYK164, DISPERBYK166, DISPERBYK167, DISPERBYK171, DISPERBYK180, DISPERBYK182, DISPERBYK2000, DISPERBYK2001, DISPERBYK2164, Bykumen, BYK-2009, BYK-P104, BYK-P104S, BYK-2205, Anti-Terra203, Anti-Terra204, and Anti-Terra205 (all are trade names) manufactured by BYK Japan K.K.

—Leveling Agent—

The leveling agent lowers the surface tension of the first layer, such that the liquid after coating is stabilized and the curable compound and the fine particles can be easily arranged in a uniform manner.

A composition for forming a first layer used in the present invention can contain at least one leveling agent.

Accordingly, it is possible to suppress film thickness unevenness and the like caused by drying unevenness due to local distribution of drying air, to improve cissing of a coated product, or to easily arrange the curable compound and the fine particle in a uniform manner.

As the leveling agent, specifically, at least one leveling agent selected from a silicone-based leveling agent or a fluorine-based leveling agent can be used. The leveling agent is preferably an oligomer or a polymer rather than a low molecular compound.

In a case where the leveling agent is added, the leveling agent quickly moves to the surface of the applied coating film and becomes unevenly distributed. Since the leveling agent is unevenly distributed on the surface even after the coating film is dried, the surface energy of the film to which the leveling agent is added is lowered by the leveling agent. In view of preventing film thickness unevenness, cissing, and unevenness, it is preferable that the surface energy of the film is low.

Preferable examples of the silicone-based leveling agent include a polymer or an oligomer including a plurality of dimethylsilyloxy units as repeating units and having substituents at a terminal and/or a side chain. A polymer or an oligomer including dimethylsilyloxy as repeating units may include a structural unit in addition to dimethylsilyloxy. The substituent may be identical to or different from each other and it is preferable to include a plurality of substituents. Examples of preferable substituents include groups including a polyether group, an alkyl group, an aryl group, an aryloxy group, an aryl group, a cinnamoyl group, an oxetanyl group, a fluoroalkyl group, a polyoxyalkylene group, or the like.

The number-average molecular weight of the silicone-based leveling agent is not particularly limited, and the number-average molecular weight is preferably 100,000 or less, more preferably 50,000 or less, particularly preferably 1,000 to 30,000, and the most preferably 1,000 to 20,000.

Examples of preferable silicone-based leveling agents include X22-3710, X22-162C, X22-3701E, X22160AS, X22170DX, X224015, X22176DX, X22-176F, X224272, KF8001, and X22-2000 manufactured by Shin-Etsu Chemical Co., Ltd.; FM4421, FM0425, FMDA26, FS1265, and the like manufactured by Chisso Corporation; BY16-750, BY16880, BY16848, SF8427, SF8421, SH3746, SH8400, SF3771, SH3749, SH3748, and SH8410 manufactured by Dow Coming Corporation; and TSF series (TSF4460, TSF4440, TSF4445, TSF4450, TSF4446, TSF4453, TSF4452, TSF4730, TSF4770, and the like), FGF502, SILWET series (SILWETL77, SILWETL2780, SILWETL7608, SILWETL7001, SILWETL7002, SILWETL7087, SILWETL7200, SILWETL7210, SILWETL7220, SILWETL7230, SILWETL7500, SILWETL7510, SILWETL7600, SILWETL7602, SILWETL7604, SILWETL7604, SILWETL7605, SILWETL7607, SILWETL7622, SILWETL7644, SILWETL7650, SILWETL7657 SILWETL8500, SILWETL8600, SILWETL8610, SILWETL8620, and SILWETL720) manufactured by Momentive Performance Materials Inc. as commercially available silicone-based leveling agents not having an ionizing radiation curing group, but the present invention is not limited thereto.

Examples of the silicone-based leveling agents having ionizing radiation curing groups include X22-163A, X22-173DX, X22-163C, KF101, X22164A, X24-8201, X22174DX, X22164C, X222426, X222445, X222457, X222459, X22245, X221602, X221603, X22164E, X22164B, X22164C, X22164D, and TM0701 manufactured by Shin-Etsu Chemical Co., Ltd., Silaplane series (FM0725, FM0721, FM7725, FM7721, FM7726, FM7727, and the like) manufactured by Chisso Corporation; SF8411, SF8413, BY16-152D, BY16-152, BY16-152C, 8388A, and the like manufactured by Dow Corning Corporation; TEGO Rad2010, 2011, 2100, 2200N, 2300, 2500, 2600, 2700, and the like manufactured by Evonik Japan Co., Ltd.; BYK3500 manufactured by BYK Japan K.K.; KNS5300 manufactured by Shin-Etsu Chemical Co., Ltd.; and UVHC1105, UVHC8550, and the like manufactured by Momentive Performance Materials Inc., but the present invention is not limited thereto.

The content of the leveling agent is preferably 001 to 5.0 mass %, more preferably 0.01 to 2.0 mass %, and most preferably 0.01 to 1.0 mass % with respect to the total solid content of the composition for forming a first layer.

The fluorine-based leveling agent is a compound of a fluoroaliphatic group and an amphipathic group that contributes to affinity for various compositions for coating or molding materials, and the like in a case where this leveling agent is used as an additive in the same molecule, and this compound can generally be obtained by copolymerizing a monomer having a fluoroaliphatic group and a monomer having an amphipathic group.

Representative examples of the monomer having an amphipathic group copolymerized with a monomer having a fluoroaliphatic group include poly(oxyalkylene) acrylate and poly(oxyalkylene) methacrylate.

As preferable commercially available fluorine-based leveling agents, examples of the leveling agent not having an ionizing radiation curing group include MEGAFACE series (MCF350-5, F472, F476, F445, F444, F443, F178, F470, F475, F479, F477, F482, F486, TF1025, F478, F178K, F-784-F, and the like) manufactured by DIC Corporation; and FTERGENT series (FTX218, 250, 245M, 209F, 222F, 245F, 208G, 218G, 240G, 206D, 240D, and the like) manufactured by NEOS Co., Ltd., and examples of the leveling agent having an ionizing radiation curing group include OPTOOL DAC manufactured by Daikin Industries, Ltd.; and DEFENSA series (TF3001, TF3000, TF3004, TF3028, TF3027, TF3026, TF3025, and the like) and RS series (RS71, RS101, RS102, RS103, RS104, RS105, and the like) manufactured by DIC Corporation, but the present invention is not limited thereto.

Compounds disclosed in JP2004-331812A and JP2004-163610A can be used.

(Antifouling Agent)

For the purpose of providing characteristics such as antifouling properties, water resistance, chemical resistance, and slidability, well-known silicone-based or fluorine-based antifouling agent, lubricant, or the like can be appropriately added to the first layer.

As the specific examples of the silicone-based or fluorine-based antifouling agent, leveling agents having an ionizing radiation curing group among the silicone-based or fluorine-based leveling agents described above can be appropriately used, but the present invention is not limited thereto.

The content of the antifouling agent is preferably 0.01 to 5.0 mass %, more preferably 0.01 to 2.0 mass %, and most preferably 0.01 to 1.0 mass % with respect to the total solid content thereof in the first layer.

(Polymerization Initiator)

The first layer may include a polymerization initiator and preferably includes a photopolymerization initiator.

Examples of the photopolymerization initiator include acetophenones, benzoins, benzophenones, phosphine oxides, ketals, anthraquinones, thioxanthones, an azo compound, peroxides, 2,3-dialkyldione compounds, disulfide compounds, fluoroamine compounds, aromatic sulfoniums, lophine dimers, onium salts, borate salts, active esters, active halogens, an inorganic complex, and coumarins. Specific examples, preferable aspects, commercially available products and the like of the photopolymerization initiator are disclosed in paragraphs <0133> to <0151> of JP2009-098658A and can be appropriately used in the present invention in the in the same manner.

Various photopolymerization initiators are provided in “Newest UV curing technology” {Technical Information Institute Co. Ltd.} (1991), page 159 and “Ultraviolet Curing System” written by Kiyomi KATO (published in 1989 by The Integrated Technology Center), pages 65 to 148, and are useful in the present invention.

The content of the polymerization initiator in the first layer is an amount sufficient for polymerizing the polymerizable compound included in the first layer and is preferably 0.1 to 8 mass % and more preferably 0.5 to 5 mass % with respect to the total solid content in the first layer such that the starting point does not excessively increase.

For the reaction of the silane coupling agent having a polymerizable functional group described above, a compound that generates an acid or a base by light or heat (hereinafter, sometimes referred to as a photoacid generator, a photobase generator, a thermal acid generator, or a thermal base generator) may be included in the first layer.

(Photoacid Generator)

Examples of the photoacid generator include an onium salt such as a diazonium salt, an ammonium salt, a phosphonium salt, an iodonium salt, a sulfonium salt, a selenonium salt, and an arsonium salt, an organohalogen compound, organometallic/organic halide, a photoacid generator having an o-nitrobenzyl-based protecting group, a compound that is photolyzed to generate sulfonic acid and is represented by iminosulfonate and the like, a disulfone compound, diazoketosulfone, and a diazodisulfone compound. Examples thereof also include triazines (for example, 2-(4-methoxyphenyl)-4,6-bis(trichloromethyl)-1,3,5-triazine, and the like), quaternary ammonium salts, a diazomethane compound, an imide sulfonate compound, and an oxime sulfonate compound.

A group that generates an acid by light or a compound obtained by introducing a compound into a main chain or a side chain of a polymer can be used.

Compounds that generate an acid by light which are disclosed in V. N. R. Pillai, Synthesis, (1), 1 (1980), A. Abad et al., Tetrahedron Lett., (47) 4555 (1971), D. H. R. Barton et al., J. Chem. Soc., (C), 329 (1970), U.S. Pat. No. 3,779,778A, and EP126,712B can be used.

(Thermal Acid Generator)

Examples of the thermal acid generator include salt including an acid and an organic base.

Examples of the acid described above include an organic acid such as sulfonic acid, phosphonic acid, and carboxylic acid and an inorganic acid such as sulfuric acid and phosphoric acid. In view of compatibility with the curable compound, an organic acid is more preferable, sulfonic acid and phosphonic acid are more preferable, and sulfonic acid is most preferable. Preferable examples of sulfonic acid include p-toluenesulfonic acid (PTS), benzenesulfonic acid (BS), p-dodecylbenzenesulfonic acid (DBS), p-chlorobenzenesulfonic acid (CBS), 1,4-naphthalenedisulfonic acid (NDS), methanesulfonic acid (MsOH), and nonafluorobutane-1-sulfonic acid (NFBS).

As specific examples of the acid generator, acid generators disclosed in JP2016-000803A can be appropriately used.

(Photobase Generator)

Examples of the photobase generator include a substance that generates bases by the action of active energy rays. More specifically, (1) a salt of organic acid and a base which is decomposed by decarburization by irradiation with ultraviolet rays, visible light, or infrared rays, (2) a compound decomposed by intramolecular nucleophilic substitution reaction or dislocation reaction to emit amines, or (3) a substance which causes some chemical reaction by irradiation with ultraviolet rays, visible light, or infrared rays to emit a base can be used.

The photobase generator used in the present invention is not particularly limited, as long as the photobase generator is a substance that generates a base by the action of active energy rays such as ultraviolet rays, electron beams, X-rays, infrared rays, and visible light.

Specifically, photobase generators disclosed in JP2010-243773A can be appropriately used.

The content of the compound that generates an acid or a base by light or heat in the first layer is an amount sufficient for polymerizing the polymerizable compound included in the first layer and is preferably 0.1 to 8 mass % and more preferably 0.1 to 5 mass % with respect to the total solid content in the first layer such that the starting point does not excessively increase.

<<Second Step>>

The second step is a step of bonding the pressure sensitive adhesive film 33 having the pressure sensitive adhesive layer 32 on the substrate 31 to the first layer 15.

The method of bonding the first layer 15 and the pressure sensitive adhesive film 33 is not particularly limited, and well-known methods may be used. Examples thereof include a lamination method.

The pressure sensitive adhesive film 33 is bonded such that the first layer 15 and the pressure sensitive adhesive layer 32 are in contact with each other.

Before the second step, a step of drying the first layer may be provided. The drying temperature of the first layer 15 is preferably 20° C. to 60° C. and more preferably 20° C. to 40° C. The drying time is preferably 0.1 to 120 seconds and more preferably 1 to 30 seconds.

<Pressure Sensitive Adhesive Film>

The pressure sensitive adhesive film 33 has a substrate and a pressure sensitive adhesive layer.

<Substrate>

The substrate 31 in the pressure sensitive adhesive film 33 is described below.

As the substrate 31, a plastic film formed of a resin having transparency and flexibility is preferably used. Preferable examples of the plastic film for the support include a film formed of a polyester film such as polyethylene terephthalate, polyethylene naphthalate, polyethylene isophthalate, and polybutylene terephthalate, a (meth)acrylic resin, a polycarbonate-based resin, a polystyrene-based resin, a polyolefin-based resin, a cyclic polyolefin-based resin, and a cellulose-based resin such as cellulose acylate. Here, the (meth)acrylic resin preferably includes a polymer having a lactone ring structure, a polymer having a glutaric acid anhydride ring structure, and a polymer having a glutarimide ring structure.

Other plastic films can be used as long as the plastic films have required strength and optical suitability. The support may be an unstretched film or may be uniaxially or biaxially stretched. Otherwise, the support may be a plastic film in which an angle of the axis method formed according to the stretching ratio and stretching crystallization is controlled.

As the substrate 31 having those having ultraviolet permeability are preferable. It is preferable to have ultraviolet permeability in view of manufacturing suitability, since in the fourth step, ultraviolet irradiation from the coating layer side can be performed in a case of curing the first layer 15.

Specifically, the maximum transmittance of the substrate 31 at the wavelength of 250 nm to 300 nm is preferably 20% or more, more preferably 40% or more, and most preferably 60% or more. It is preferable that the maximum transmittance at the wavelength of 250 nm to 300 nm is 20% or more, since the first layer can be easily cured by being irradiated with ultraviolet rays from the coating layer side.

Specifically, the maximum transmittance of the pressure sensitive adhesive film 33 in which the pressure sensitive adhesive layer 32 is formed on the substrate 31 at the wavelength of 250 nm to 300 nm is preferably 20% or more, more preferably 40% or more, and most preferably 60% or more.

The film thickness of the substrate 31 is not particularly limited, but is preferably 10 μm to 100 μm, more preferably 10 μm to 50 μm, and even more preferably 10 μm to 40 μm.

(Pressure Sensitive Adhesive Layer)

It is preferable that the pressure sensitive adhesive layer 32 is formed of a pressure sensitive adhesive having a gel fraction of 95.0% or more.

In a case where the gel fraction of the pressure sensitive adhesive 32 is 95.0% or more, in a case where the pressure sensitive adhesive film is peeled off from the laminate of the present invention to manufacture the antireflection film, it is possible to obtain the antireflection film in which a component of the pressure sensitive adhesive hardly remains on a surface of the antireflection film even in a case where washing is not performed, and reflectance is sufficiently low.

The gel fraction of the pressure sensitive adhesive 32 is preferably in the range of 95.0% to 99.9%, more preferably in the range of 97.0% to 99.9%, and even more preferably in the range of 98.0% to 99.9%.

The gel fraction of the pressure sensitive adhesive 32 is a proportion of an insoluble matter after the pressure sensitive adhesive is immersed in tetrahydrofuran (THF) at 25° C. for 12 hours and is obtained from the following expression.

Gel fraction=(mass of insoluble matter of pressure sensitive adhesive in THF)/(total mass of pressure sensitive adhesive)×100(%)

The weight-average molecular weight of the sol component in the pressure sensitive adhesive 32 is preferably 10,000 or less, more preferably 7,000 or less, and most preferably 5,000 or less. By setting the weight-average molecular weight of the sol component within the above range, the component of the pressure sensitive adhesive can be caused to hardly remain on the surface of the antireflection film in a case where the pressure sensitive adhesive film is peeled off from the laminate of the present invention to manufacture an antireflection film.

The sol component of the pressure sensitive adhesive 32 represents a dissolution amount in THF after the pressure sensitive adhesive is immersed in tetrahydrofuran (THF) at 25° C. for 12 hours. The weight-average molecular weight can be analyzed by gel permeation chromatography (GPC).

The film thickness of the pressure sensitive adhesive layer 32 is preferably 0.1 μm to 50 μm, more preferably 1 μm to 30 μm, and even more preferably 1 μm to 20 μm.

The pressure sensitive adhesive layer 32 is preferably a pressure sensitive adhesive layer having a slight pressure sensitive adhesive strength in which a peeling strength (pressure sensitive adhesive strength) to a surface of an adherend at a peeling rate of 0.3 m/min is about 0.03 to 0.3 N/25 mm, since operability in a case of peeling off the pressure sensitive adhesive film 33 from the first layer which is the adherend is excellent.

The pressure sensitive adhesive preferably includes a polymer and more preferably includes a (meth)acrylic polymer. Particularly, a polymer (in a case where two or more kinds of monomers, a copolymer) of at least one monomer of (meth)acrylic acid alkyl ester monomers having an alkyl group of 1 to 18 carbon atoms is preferable. The weight-average molecular weight of the (meth)acrylic polymer is preferably 200,000 to 2,000,000.

Examples of the (meth)acrylic acid alkyl ester monomer in Which an alkyl group has 1 to 18 carbon atoms include an alkyl (meth)acrylate monomer such as methyl (meth)acrylate, ethyl (meth)acrylate, propyl (meth)acrylate, butyl (meth)acrylate, isobutyl (meth)acrylate, pentyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, isononyl (meth)acrylate, decyl (meth)acrylate, cyclopentyl (meth)acrylate, cyclohexyl (meth)acrylate, isomyristyl (meth)acrylate, isocetyl (meth)acrylate, isostearyl (meth)acrylate, myristyl (meth)acrylate, cetyl (meth)acrylate, stearyl (meth)acrylate, tetradecyl (meth)acrylate, pentadecyl (meth)acrylate, hexadecyl (meth)acrylate, heptadecyl (meth)acrylate, and octadecyl (meth)acrylate. The alkyl group of the alkyl (meth)acrylate monomer may be linear, branched or cyclic. Two or more of the monomers may be used in combination.

Preferable examples of the (meth)acrylate monomer having an aliphatic ring include cyclopentyl (meth)acrylate, cyclohexyl (meth)acrylate, cycloheptyl (meth)acrylate, and isobornyl (meth)acrylate. Among these, cyclohexyl (meth)acrylate is particularly preferable.

The (meth)acrylic polymer is a copolymer including at least one of (meth)acrylic acid alkyl ester monomers having an alkyl group of 1 to 18 carbon atoms and at least one of other copolymerizable monomers. In this case, examples of the other copolymerizable monomers include a copolymerizable vinyl monomer containing at least one group selected from a hydroxyl group, a carboxyl group, and an amino group, a copolymerizable vinyl monomer having a vinyl group, or an aromatic monomer.

Examples of the copolymerizable vinyl monomer containing a hydroxyl group include hydroxyl group-containing (meth)acrylic acid esters such as 2-hydroxyethyl (meth)acrylate, 2-hydroxypropyl (meth)acrylate, 3-hydroxypropyl (meth)acrylate, 4-hydroxybutyl (meth)acrylate, 6-hydroxyhexyl (meth)acrylate, and 8-hydroxyoctyl (meth)acrylate, and hydroxyl group-containing (meth)acrylamides such as N-hydroxy (meth)acrylamide, N-hydroxymethyl (meth)acrylamide, and N-hydroxyethyl (meth)acrylamide, and the copolymerizable vinyl monomer is preferably at least one selected from the group of these compounds.

It is preferable that the content of the copolymerizable vinyl monomer containing a hydroxyl group is 0.1 to 15 parts by mass with respect to 100 parts by mass of the (meth)acrylic polymer.

Examples of the copolymerizable vinyl monomer containing a carboxyl group include (meth)acrylic acid, itaconic acid, crotonic acid, maleic acid, fumaric acid, carboxyethyl (meth)acrylate, and carboxypentyl (meth)acrylate, and at least one selected from the group of these compounds is preferable.

The content of the copolymerizable vinyl monomer containing a carboxyl group is preferably 0.1 to 2 parts by mass with respect to 100 parts by mass of the (meth)acrylic copolymer.

Examples of the copolymerizable vinyl monomer containing an amino group include monoalkylaminoalkyl (meth)acrylate such as monomethylaminoethyl (meth)acrylate, monoethylaminoethyl (meth)acrylate, monomethylaminopropyl (meth)acrylate, and monoethylaminopropyl (meth)acrylate.

Examples of the aromatic monomer include styrene in addition to aromatic group-containing (meth)acrylic acid esters such as benzyl (meth)acrylate and phenoxyethyl (meth)acrylate.

Examples of the copolymerizable vinyl monomer other than the above include various vinyl monomers such as acrylamide, acrylonitrile, methyl vinyl ether, ethyl vinyl ether, vinyl acetate, and vinyl chloride.

The pressure sensitive adhesive may include a cured product of a composition (also referred to as a pressure sensitive adhesive layer composition) for forming the pressure sensitive adhesive layer.

The pressure sensitive adhesive layer composition preferably includes the polymer and the crosslinking agent, and may be crosslinked by heat, ultraviolet rays (UV), or the like. The crosslinking agent is preferably one or more crosslinking agents selected from a compound group consisting of a difunctional or higher functional isocyanate-based crosslinking agent, a difunctional or higher functional epoxy-based crosslinking agent, and an aluminum chelate-based crosslinking agent. In a case where a crosslinking agent is used, in view of causing the component of the pressure sensitive adhesive not to remain on the surface of the antireflection film in a case where the pressure sensitive adhesive film is peeled off from the laminate of the present invention to manufacture the antireflection film, the content of the crosslinking agent is preferably 0.1 to 15 parts by mass, more preferably 3.5 to 15 parts by mass, and even more preferably 5.1 to 10 parts by mass with respect to 100 parts by mass of the polymer.

The difunctional or higher functional isocyanate-based compound may be a polyisocyanate compound having at least two isocyanate (NCO) groups in one molecule, and examples thereof include a burette-modified product and an isocyanurate-modified product of diisocyanates (compounds having two NCO groups in one molecule) such as hexamethylene diisocyanate, isophorone diisocyanate, diphenylmethane diisocyanate, tolylene diisocyanate, and xylylene diisocyanate, and an adduct (polyol modified product) with trivalent or higher valent polyols (compounds having at least three OH groups in one molecule) such as trimethylolpropane and glycerin.

A trifunctional or higher functional isocyanate-based compound is a polyisocyanate compound having at least three or more isocyanate (NCO) groups in one molecule, and. particularly at least one or more selected from the compound group consisting of an isocyanurate body of a hexamethylene diisocyanate compound, an isocyanurate body of an isophorone diisocyanate compound, an adduct of hexamethylene diisocyanate compound, an adduct of isophorone diisocyanate compound, a burette body of a hexamethylene diisocyanate compound, and a burette body of an isophorone diisocyanate compound are preferable.

The difunctional or higher functional isocyanate-based crosslinking agent is contained in an amount of preferably 0.01 to 5.0 parts by mass and more preferably 0.02 to 3.0 parts by Mass, with respect to 100 parts by mass of the polymer.

The pressure sensitive adhesive layer composition may contain an antistatic agent in order to provide antistatic performances. The antistatic agent is preferably an ionic compound and more preferably quaternary onium salt.

As the antistatic agent which is a quaternary onium salt, for example, an alkyldimethylbenzyl ammonium salt having an alkyl group having 8 to 18 carbon atoms, a dialkylmethylbenzyl ammonium salt having an alkyl group having 8 to 18 carbon atoms, a trialkylbenzyl ammonium salt having an alkyl group having 8 to 18 carbon atoms, a tetraalkyl ammonium salt having an alkyl group having 8 to 18 carbon atoms, an alkyldimethylbenzyl phosphonium salt having an alkyl group having 8 to 18 carbon atoms, a dialkylmethylbenzyl phosphonium salt having an alkyl group having 8 to 18 carbon atoms, a trialkylbenzyl phosphonium salt having an alkyl group having 8 to 18 carbon atoms, a tetraalkyl phosphonium salt having an alkyl group having 8 to 18 carbon atoms, an alkyl trimethyl ammonium salt having an alkyl group having 14 to 20 carbon atoms, and an alkyldimethyl ethyl ammonium salt having an alkyl group having 14 to 20 carbon atoms can be used. These alkyl groups may be alkenyl groups having an unsaturated bond.

Examples of the alkyl group having 8 to 18 carbon atoms include an octyl group, a nonyl group, a decyl group, a dodecyl group, a tridecyl group, a tetradecyl group, a pentadecyl group, a hexadecyl group, a heptadecyl group, and an octadecyl group. The alkyl group having 8 to 18 carbon atoms may be a mixed alkyl group derived from natural fats and oils. Examples of the alkenyl group having 8 to 18 carbon atoms include an octenyl group, a nonenyl group, a decenyl group, a dodecenyl group, a tridecenyl group, a tetradecenyl group, a pentadecenyl group, a hexadecenyl group, a heptadecenyl group, an octadecenyl group, an oleyl group, and a linoleyl group.

Examples of the alkyl group having 14 to 20 carbon atoms include a tetradecyl group, a pentadecyl group, a hexadecyl group, a heptadecyl group, an octadecyl group, a nonadecyl group, and an icosyl group. The alkyl group having 14 to 20 carbon atoms may be a mixed alkyl group derived from natural fats and oils. Examples of the alkenyl group having 14 to 20 carbon atoms include a tetradecenyl group, a pentadecenyl group, a hexadecenyl group, a heptadecenyl group, an octadecenyl group, an oleyl group, a linoleyl group, a nonadecenyl group, and an icosenyl group.

Examples of a counter anion of the quaternary onium salt include chloride (Cl⁻), bromide (Br⁻), methyl sulfate (CH₃OSO₃⁻), ethyl sulfate (C₂H₅OSO₃⁻), and paratoluene sulfonate (p-CH₃C₆H₄SO₃⁻).

Specific examples of the quaternary onium salt include dodecyl dimethyl benzyl ammonium chloride, dodecyl dimethyl benzyl ammonium bromide, tetradecyl dimethyl benzyl ammonium chloride, tetradecyldimethylbenzyl ammonium bromide, hexadecyl dimethyl benzyl ammonium chloride, hexadecyl dimethyl benzyl ammonium bromide, octadecyl dimethyl benzyl ammonium chloride, octadecyldimethylbenzyl ammonium bromide, trioctylbenzylammonium chloride, trioctylbenzylammonium bromide, trioctylbenzylphosphonium chloride, trioctylbenzylphosphonium bromide, tris(decyl)benzylammonium chloride, tris(decyl)benzylammonium bromide, tris(decyl)benzylphosphonium chloride, tris(decyl)benzylphosphonium bromide, tetraoctyl ammonium chloride, tetraoctyl ammonium bromide, tetraoctylphosphonium chloride, tetraoctylphosphonium bromide, tetranonyl ammonium chloride, tetranonyl ammonium bromide, tetranonyl phosphonium chloride, tetranonylphosphonium bromide, tetrakis(decyl)ammonium chloride, tetrakis(decyl)ammonium bromide, tetrakis(decyl)phosphonium chloride, and tetrakis(decyl)phosphonium bromide.

“Tris(decyl)” and “tetrakis (decyl)” mean having 3 or 4 decyl groups which are alkyl groups having 10 carbon atoms and is different from a tridecyl group which is an alkyl group having 13 carbon atoms or a tetradecyl group which is an alkyl group having 14 carbon atoms.

As the antistatic agent, in addition to the above, nonionic, cationic, anionic, and. amphoteric surfactants, ionic liquid, alkali metal salt, metal oxide, metal fine particles, a conductive polymer, carbon, a carbon nanotube can be used.

Examples of the nonionic surfactant include polyoxyethylene alkyl ethers, polyoxyethylene alkyl phenyl ethers, sorbitan fatty acid esters, polyoxyethylene sorbitan fatty acid esters, polyoxyethylene fatty acid esters, glycerin fatty acid esters, propylene glycol fatty acid esters, and polyoxyalkylene-modified silicones.

Examples of the anionic surfactant include monoalkyl sulfate, alkyl polyoxyethylene sulfates, alkylbenzenesulfonic acid salts, and monoalkyl phosphates.

Examples of the amphoteric surfactant include alkyldimethylamine oxide and alkylcarboxy betaine.

The ionic liquid is a non-polymeric substance including anions and cations and being liquid at normal temperature (for example, 25° C.). Examples of the cation portion include a cyclic amidine ion such as an imidazolium ion, a pyridinium ion, an ammonium ion, a sulfonium ion, and a phosphonium ion. Examples of the anion portion include CₙH₂ₙ₊₁COO⁻, CₙF₂ₙ₊₁COO⁻, NO₃⁻, CₙF₂ₙ₊₁SO₃⁻, (CₙF₂ₙ₊₁SO₂)₂N⁻, (CₙF₂ₙ₊₁SO₂)₃C⁻, PO₄²⁻, AlCl₄⁻, Al₂Cl₇⁻, ClO₄⁻, BF₄⁻, PF₆⁻, AsF₆⁻and SbF₆⁻.

Examples of the alkali metal salt include metal salt including lithium, sodium, and potassium. In order to stabilize ionic substances, a compound containing a polyoxyalkylene structure may be added.

The antistatic agent preferably contains 0.1 to 10 parts by mass with respect to 100 parts by mass of the polymer.

The pressure sensitive adhesive composition can further contain a polyether-modified siloxane compound having HLB of 7 to 15 as an antistatic aid.

HLB is a hydrophilic-lipophilic balance (hydrophilicity and lipophilicity ratio) defined, for example, by JIS K3211 (surfactant term) and the like.

The pressure sensitive adhesive composition can further contain a crosslinking accelerator. In a case where a polyisocyanate compound is used as a crosslinking agent, the crosslinking accelerator may be a substance, functioning as a catalyst for the reaction (crosslinking reaction) between the copolymer and the crosslinking agent, and examples thereof include an amine-based compound such as tertiary amine, and an organometallic compound such as a metal chelate compound, an organotin compounds, an organic lead compound, organozinc compound. According to the present invention, the crosslinking accelerator is preferably a metal chelate compound or an organotin compound.

The metal chelate compound is a compound obtained by bonding one or more polydentate ligands L to the central metal atom M. The metal chelate compound may or may not have one or more monodentate ligands X bonded to the metal atom M. For example, a formula of a metal chelate compound having one metal atom M is represented by M(L)ₘ(X)ₙ, m≥1 and n≥0. In a case where in is 2 or more, m items of L's may be the same ligands or different ligands. In a case where n is 2 or more. n X's may be the same ligand or different ligands.

Examples of the metal atom M include Fe, Ni, Mn, Cr, V, Ti, Ru, Zn, Al, Zr, and Sn. Examples of the polydentate ligand L include β-ketoester such as methyl acetoacetate, ethyl acetoacetate, octyl acetoacetate, oleyl acetoacetate, lauryl acetoacetate, and stearyl acetoacetate, and β-diketone such as acetylacetone (also referred to as 2,4-pentanedione), 2,4-hexanedione, and benzoylacetone. These are ketoenol tautomeric compounds, and in the polydentate ligand L, enolate obtained by deprotonating enol (for example, acetylacetonate) may be used.

Examples of the monodentate ligand X include a halogen atom such as a chlorine atom and a bromine atom, an acyloxy group such as a pentanoyl group, a hexanoyl group, a 2-ethylhexanoyl group, an octanoyl group, a nonanoyl group, a decanoyl group, a dodecanoyl group, and an octadecanoyl group, and an alkoxy group such as a methoxy group, an ethoxy group, an n-propoxy group, an isopropoxy group, and a butoxy group.

Specific examples of the metal chelate compound include tris(2,4-pentanedionato) (III), iron trisacetyl acetonate, titanium trisacetyl acetonate, ruthenium trisacetyl acetonate, zinc bisacetyl acetonate, aluminum trisacetyl acetonate, zirconium tetrakis acetyl acetonate, tris(2,4-hexanedionato) iron (III), bis(2,4-hexanedionato) zinc, tris(2,4-hexanedionato) titanium, tris(2,4-hexanedionato) aluminum, and tetrakis(2,4-hexanedionato) zirconium.

Examples of the organotin compound include dialkyl tin oxide, a fatty acid salt of dialkyl tin, and a fatty acid salt of stannous tin. A long-chain alkyl tin compound such as a dioctyl tin compound is preferable. Specific examples of the organotin compound include dioctyl tin oxide and dioctyl tin dilaurate.

The content of the crosslinking accelerator is preferably 0.001 to 0.5 parts by mass with respect to 100 parts by mass of the copolymer.

As the pressure sensitive adhesive film 33 obtained by forming the pressure sensitive adhesive layer 32 on the substrate 31, a commercially available protective film can be suitably used. Specific examples thereof include AS3-304, AS3-305, AS3-306, AS3-307, AS3-310, AS3-0421, AS3-0520, AS3-0620, LBO-307, NBO-0424, ZBO-0421, S-362, and TFB-4T3-367AS manufactured by Fujimori Kogyo Co., Ltd.

<<Third Step>>

The third step is a step of burying the fine particle 13 in the layer 17 obtained by combining the first layer 15 and the pressure sensitive adhesive layer 32 and lowering the position of the interface 16 of the pressure sensitive adhesive layer 32 to the first layer 15 to the support 11 side to protrude from the interface 16 opposite to the interface of the first layer 15 on the support side.

According to the present invention, the expression “the fine particle is buried in the layer obtained by combining the first layer and the pressure sensitive adhesive layer” indicates that the thickness of the layer 17 obtained by combining the first layer 15 and the pressure sensitive adhesive layer 32 is 0.8 times or more of the average primary particle diameter of the fine particles 13.

It is preferable that the third step is performed by causing a portion of the curable compound to permeate the support 11 (which may be a functional layer, in a case where the support has a functional layer) or causing a portion of the curable compound to permeate the pressure sensitive adhesive layer 32.

In the third step, in a case where a portion of the curable compound is caused to permeate the support 11 (may be the functional layer, in a case where the support has the functional layer), it is preferable to heat a laminate having the support 11, the first layer 15, and the pressure sensitive adhesive layer 32. By the heating, it is possible to cause a portion of the curable compound to effectively permeate the substrate. The temperature in heating is preferably smaller than the glass transition temperature of the support. Specifically, the temperature is preferably 60° C. to 180° C. and more preferably 80° C. to 130° C.

In third step, in a case where a portion of the curable compound is caused to permeate a laminate having the pressure sensitive adhesive layer 32, the support 11, the first layer 15, and the pressure sensitive adhesive layer 32 is maintained preferably at less than 60° C. and more preferably at 40° C. or less. By maintaining the temperature at 40° C. or less, the viscosity of the curable compound and the pressure sensitive adhesive can be maintained to be high, and at the same time, the thermal motion of the particles can be suppressed, and thus has a high effect of suppressing the decrease of the antireflection ability due to aggregation of the particles and the increase of the haze or the muddiness. The lower limit of the temperature in which the laminate having the support 11, the first layer 15, and the pressure sensitive adhesive layer 32 is maintained is not particularly limited, and may be the room temperature or a temperature lower than the room temperature.

<<Fourth Step>>

The fourth step is a step of curing the first layer 15 in a state in which the fine particle 13 is buried in the layer 17 obtained by combining the first layer 15 and the pressure sensitive adhesive layer 32.

According to the present invention, the expression “state where the fine particle is buried in the layer obtained by combining the first layer and the pressure sensitive adhesive layer” indicates that the thickness of the layer obtained by combining the first layer and the pressure sensitive adhesive layer is 0.8 times or more of the average primary particle diameter of the fine particles.

The expression “curing the first layer 15” means polymerizing the curable compound included in the first layer 15, and a binder 14 in the completed antireflection layer of the antireflection film can be formed. In the fourth step, since a state in which the fine particles 13 is buried in the layer obtained 17 by combining the first layer 15 and the pressure sensitive adhesive layer 32 is maintained, the aggregation of the fine particles 13 is suppressed and the moth eye structure can be formed.

In a case where it is considered that the state in which the fine particle 13 is buried in the layer 17 obtained by combining the first layer 15 and the pressure sensitive adhesive layer 32 is cannot be maintained due to the volatilization of the component of the pressure sensitive adhesive layer 32 or the first layer 15 after the pressure sensitive adhesive layer 32 is provided. or the permeation of the component to the substrate 31 (the functional layer in a case where the substrate has the functional layer), an operation of thickening the pressure sensitive adhesive layer 32 in advance or the like can be performed.

As a mechanism of suppressing particle aggregation by maintaining a state in which the fine particle 13 is buried in the layer 17 obtained by combining the first layer 15 and the pressure sensitive adhesive layer 32, it is assumed that, it is known that a large attractive force derived from the surface tension called lateral capillary force works in a case where the fine particle 13 is exposed to the air interface until the first layer 15 is cured, and thus by burying the fine particle in the layer 17 obtained by combining the first layer 15 and the pressure sensitive adhesive layer 32, the attractive force can be reduced.

The curing can be performed by irradiation with ionizing radiation. The kind of ionizing radiation is not particularly limited, and examples thereof include X-rays, electron beams, ultraviolet rays, visible light, and infrared rays. However, ultraviolet rays are widely used. For example, in a case where the coating film is ultraviolet-curable, it is preferable that the curable compound of the first layer 15 is cured by being irradiated with ultraviolet rays in an irradiation amount of 10 mJ/cm² to 1,000 mJ/cm² by an ultraviolet lamp. The irradiation amount is more preferably 50 mJ/cm² to 1,000 mJ/cm² and still more preferably 100 mJ/cm² to 500 mJ/cm². At the time of irradiation, the energy may be applied at once or can be radiated in a divided manner. As the ultraviolet lamp type, a metal halide lamp, a high pressure mercury lamp, or the like is suitably used.

The oxygen concentration at the curing is preferably 0 to 1.0 vol %, more preferably 0 to 0.1 vol %, and most preferably 0 to 0.05 vol %. In a case where the oxygen concentration at curing is smaller than 1.0 vol %, curing inhibition caused by oxygen is hardly received, and the film becomes strong.

In the second to fourth steps, it is preferable that a plurality of fine particles are not present in a direction orthogonal to the surface of the support 11.

In the second to fourth steps, the total film thickness of the film thickness of the first layer 15 and the film thickness of the pressure sensitive adhesive layer 32 is preferably more than the average primary particle diameter of the fine particles.

It is preferable that the total film thickness of the film thickness of the first layer 15 and the film thickness of the pressure sensitive adhesive layer 32 is more than the average primary particle diameter of the fine particles 13, since it is possible to cause the fine particle 13 to be buried in the layer 17 obtained by combining the first layer 15 and the pressure sensitive adhesive layer 32.

However, since it is possible to obtain a shape (moth eye structure) in which the fine particle protrudes from the surface of the first layer 15 in a case where the pressure sensitive adhesive film including the pressure sensitive adhesive layer in the fifth step described below is peeled off, in the fourth step, it is preferable that the film thickness of the first layer 15 is smaller than the average primary particle diameter of the fine particle, and it is more preferable that the film thickness thereof is equal to or less than a half of the average primary particle diameter of the fine particle 13.

It is preferable that the film thickness of the first layer 15 in the fourth step is adjusted such that the height of the interface 16 on a side opposite to the interface of the layer (the layer 14 in (e) of FIG. 2), which is obtained by curing the first layer 15 on the support 11 side is equal to or less than a half of the average primary particle diameter of the fine particle 13, and it is more preferable that the film thickness thereof is adjusted such that, in a case where the film cross section is observed by a scanning electron microscope (SEM) and the film thicknesses at 100 random points are measured to obtain the average value, the average value becomes 10 nm to 100 nm, more preferably 20 nm to 90 nm, and even more preferably 30 nm to 70 nm.

The tine particle which is the same as the fine particle 13 can be used. Accordingly, it is preferable that the fine particle 13 is a fine particle surface-treated for improving the dispersibility in the coating liquid, improving the film hardness, and preventing aggregation. Specific examples and preferable examples of the surface treatment method are the same as those described in <0119> to <0147> of JP2007-298974A.

Particularly, in view of providing the binding properties to the binder component and improving the film hardness, it is preferable that the surface of the particle is surface-modified with a compound having a functional group having reactivity with an unsaturated double bond and the particle surface, and an unsaturated double bond is applied to the particle surface, and it is more preferable that a (meth)acryloyl group is applied.

According to the present invention, the first layer 15 is cured while a state in which the fine particle 13 is buried in the layer 17 obtained by combining the first layer 15 and the pressure sensitive adhesive layer 32 is maintained in the fourth step, or in the stage before the fourth step, it is preferable to have an uneven shape formed by the fine particle 13 protruding from the interface 16. In this manner, in a case where the pressure sensitive adhesive film 33 is peeled off in the fifth step after the first layer 15 is cured in the fourth step, it is possible to obtain the antireflection film in a state in which the of fine particle protrudes from the surface of the first layer 15.

In the stage before the fourth step, in order to provide an uneven shape formed by the fine particle protruding from the interface 16, in the third step described above, it is preferable to cause a portion of the curable compound to permeate a support 11 (in a case where the support has a functional layer such as a hard coat layer, a functional layer).

According to the present invention, it is possible to include a step of curing a portion of the curable compound in the first layer 15 between the first and second steps to obtain the cured compound.

In a case where a portion of the curable compound is cured in this step, the fine particle is caused to hardly move such that the aggregation of the tine particle can be suppressed.

The expression “a portion of the curable compound is cured” means that not all of the curable compound is cured, but only a portion thereof is cured. By curing a portion of the curable compound in this step, it is possible to form a satisfactory uneven shape (moth eye structure) in a case where the position of the interface 16 between the first layer 15 and the pressure sensitive adhesive layer 32 is caused to lower to the support 11 side such that the fine particle 13 protrudes from the interface 16 opposite to the interface of the first layer 15 on the support 11 side in the third step.

[Method of Manufacturing Antireflection Film]

The method of manufacturing the antireflection film according to the embodiment of the present invention includes the fifth step (see (e) of FIG. 2) of peeling off the pressure sensitive adhesive film 33 after the fourth step in the method of manufacturing a laminate according to the embodiment of the present invention, and the first to fourth steps are the same as those in the method of manufacturing a laminate, so the same reference numerals are provided, and details thereof are omitted.

By providing the fifth step of peeling off the pressure sensitive adhesive film 33, it is possible to obtain an antireflection layer comprising the antireflection layer 12 having the fine particle 13 and the binder 14 on the support 11.

[Polarizing Plate]

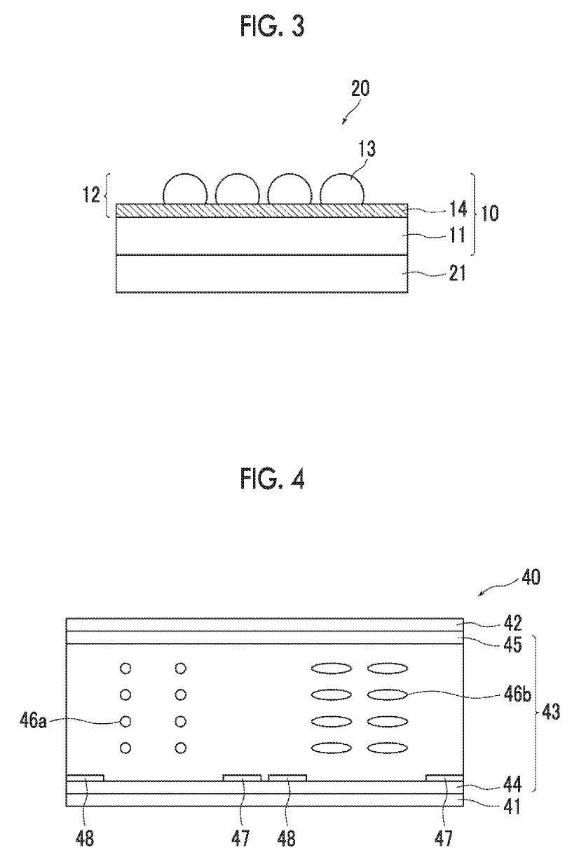

As illustrated in FIG. 3, the polarizing plate 20 is a polarizing plate having a polarizing film 21 and at least one of the protective films for protecting the polarizing film, and at least one of the protective films is the antireflection film 10.

The polarizing film 21 may be a so-called linear polarizer having a function of converting natural light into specific linearly polarized light. The polarizing film 21 is not particularly limited, but an absorptive polarizing film may be used.

The polarizing film 21 is not particularly limited, and a generally used polarizing film can be used, for example, all of an iodine-based polarizing film, a dye-based polarizing film using a dichroic dye (a dichroic organic dye), and a polyene-based polarizing film may be used. An iodine-based polarizing film and a dye-based polarizing film is manufactured by causing iodine or a dichroic dye to be adsorbed in polyvinyl alcohol and stretching the film.

The film thickness of the polarizing film 21 is not particularly limited, but is preferably 50 μm or less, more preferably 30 μm or less, and even more preferably 20 μm or less in view of thinning, The film thickness of the polarizing film 21 is generally 1 μm or more and preferably 5 μm or more.

According to the present invention, as the polarizing film 21, a thermotropic liquid crystalline dichroic coloring agent is used, and a coating type polarizing film prepared by coating is preferably used. That is, the polarizing film is preferably a layer formed from a dichroic coloring agent composition including at least one thermotropic liquid crystalline dichroic coloring agent. By using this polarizing film, thinning can be realized, and deterioration of the display performance of the display device can be further suppressed even under a wet heat environment. As the dichroic coloring agent for the coating-type polarizing film used in the present invention, coloring agents disclosed in JP2011-237513A can be suitably used.

Examples of thermotropic liquid crystalline dichroic coloring agents are provided below, but the invention is not limited to these compounds.

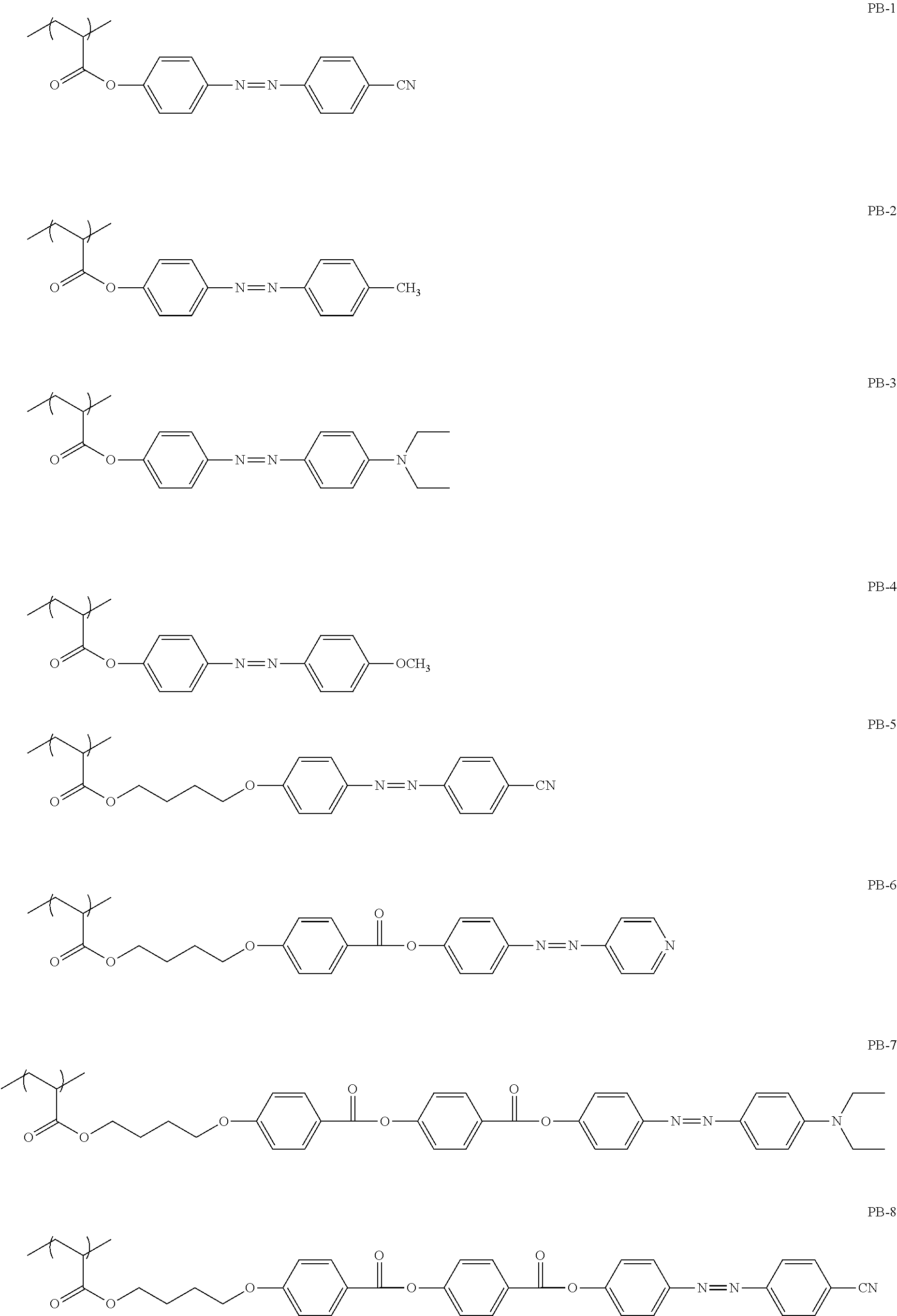

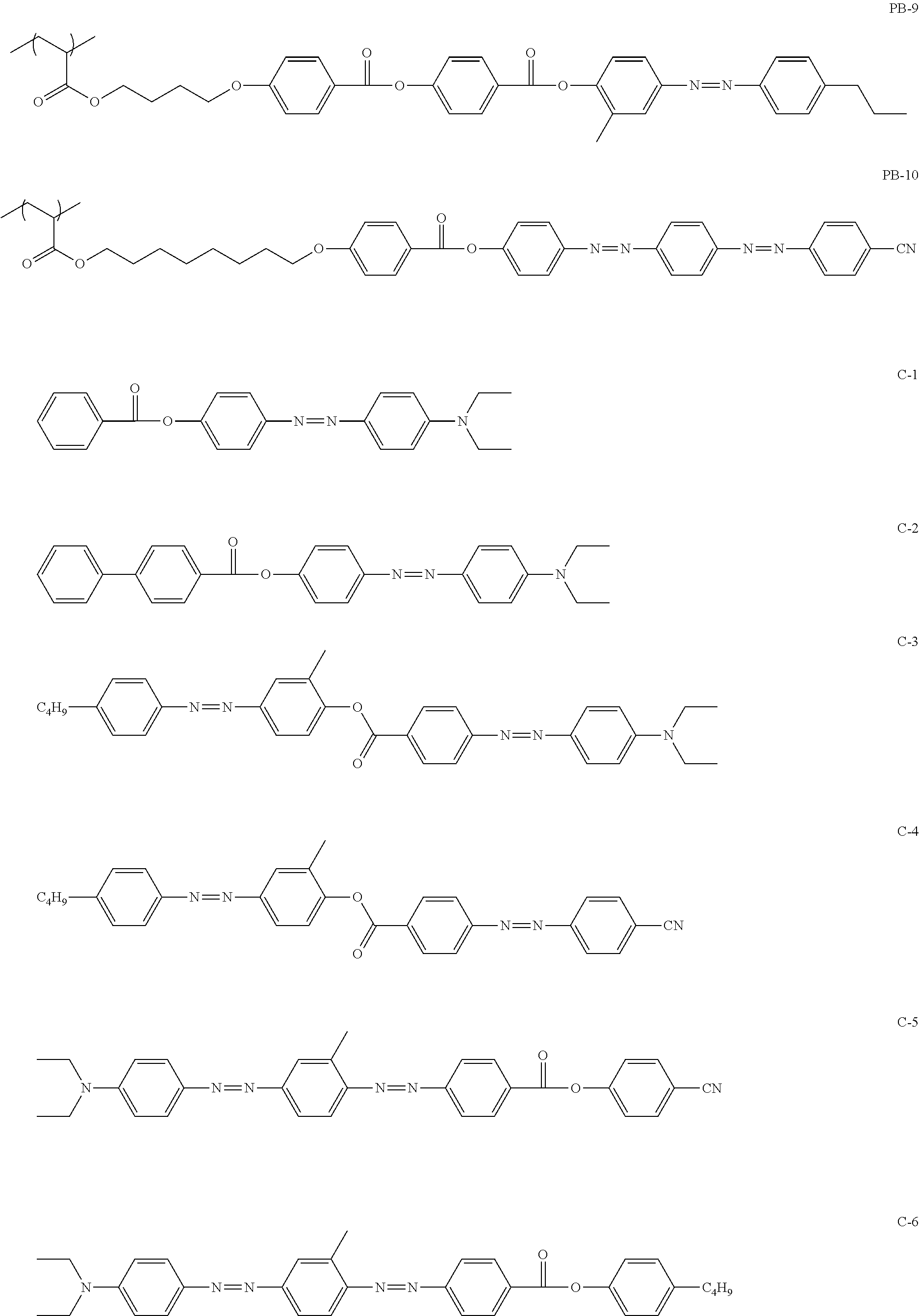

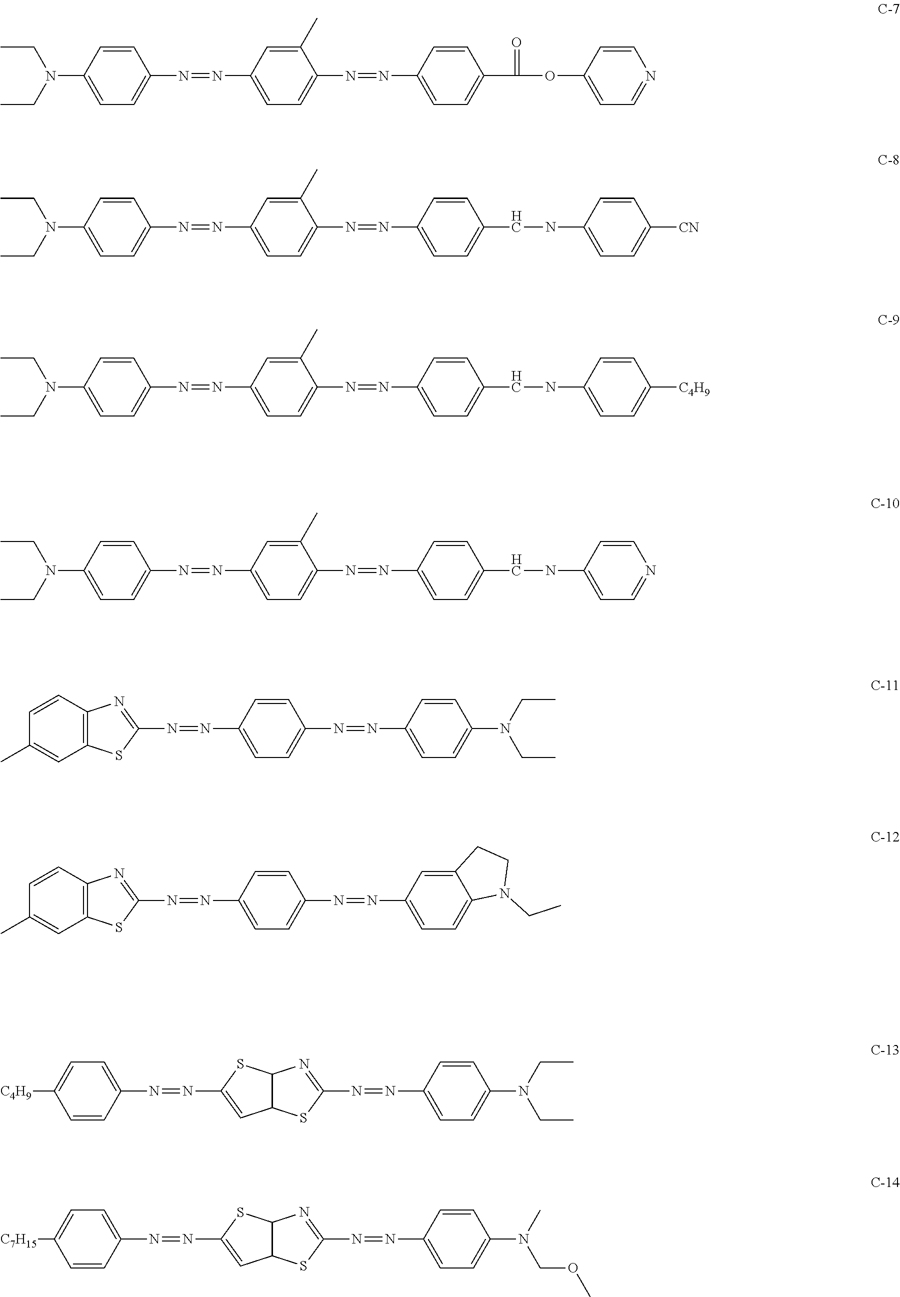

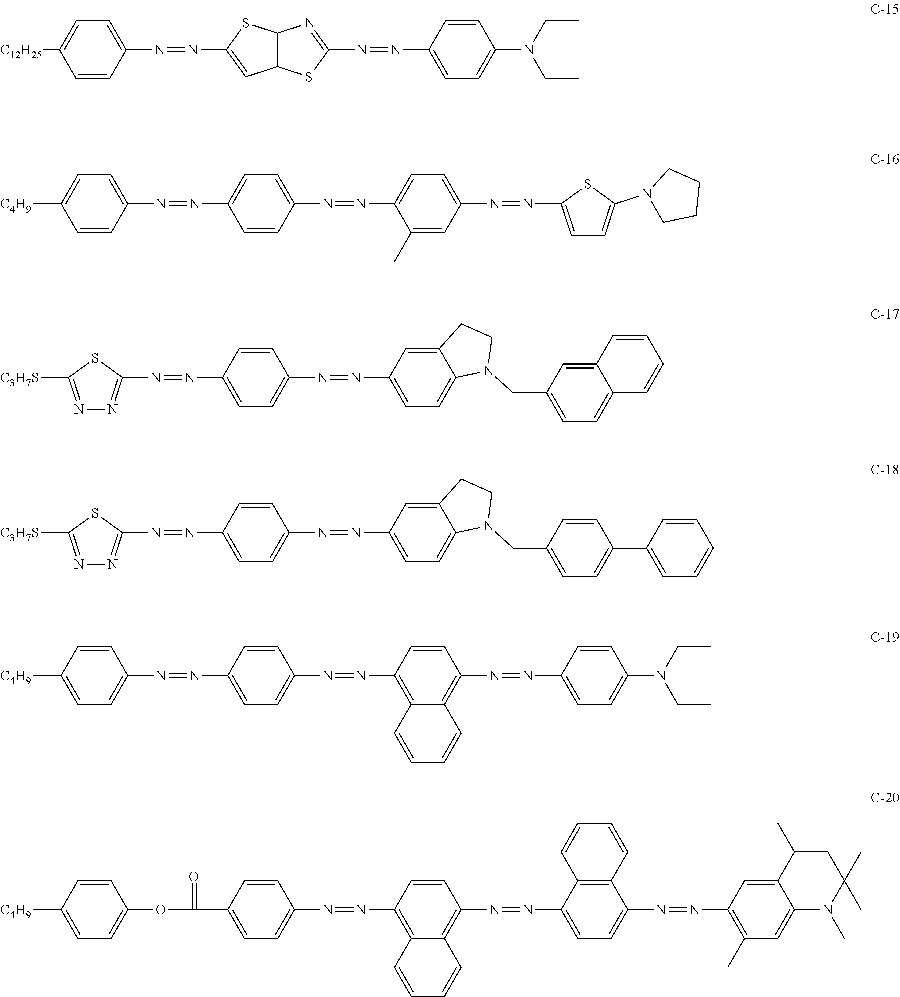

In the dichroic coloring agent composition, the proportion occupied by the non-coloring liquid crystal compound is preferably 30 mass % or less, more preferably 20 mass % or less, even more preferably 10 mass % or less, and particularly preferably 5 mass % or less. Here, the non-coloring liquid crystal compound refers to a compound which does not exhibit absorption in the spectral region of visible light, that is, in the spectral region of 400 to 700 nm and which exhibits a nematic liquid crystal phase or a smectic liquid crystal phase, and examples thereof include liquid crystal compounds disclosed in pages 154 to 192 and pages 715 to 722 of “Liquid Crystal Device Handbook” (edited by The 142-Committee of The Japan Society for Promotion of Science, Nikkan Kogyo Shimbun, Ltd., 1989).

The thickness of the polarizing film 21 formed by using the dichroic coloring agent composition is not particularly limited, but is preferably 250 nm or more, more preferably 350 nm or more, and even more preferably 450 nm or more. The upper limit is not particularly limited, but is preferably 2,000 nm or less in view of thinning.

[Image Display Device]

The antireflection film according to the embodiment of the present invention can be also applied to an image display device.

Examples of the image display device include a display device using a cathode ray tube (CRT), a plasma display panel (PDP), an electroluminescent display (ELD), a vacuum fluorescent display (VFD), a field emission display (FED), and a liquid crystal display (LCD), and a liquid crystal display device is particularly preferable.

Generally, a liquid crystal display device has a liquid crystal cell and two polarizing plates disposed on both sides of the liquid crystal cell, and the liquid crystal cell carries a liquid crystal between the two electrode substrates. One optically anisotropic layer may be disposed between the liquid crystal cell and one polarizing plate, or two optically anisotropic layers may be disposed between the liquid crystal cell and both polarizing plates. As the liquid crystal cell, liquid crystal cells of various driving methods such as a Twisted Nematic (TN) mode, a Vertically Aligned (VA) mode, an Optically Compensatory Bend (OCB) mode, and an In-Plane Switching (IPS) mode can be applied.

<IPS-Type Liquid Crystal Display Device>

An IPS-type liquid crystal display device is described as an embodiment of an image display device comprising the polarizing plate according to the embodiment of the present invention. A schematic cross-sectional view of an IPS-type liquid crystal display device is illustrated in FIG. 4.

As illustrated in FIG. 4, with respect to an IPS-type liquid crystal display device 40 according to the present embodiment, an IPS-type liquid crystal cell 43 is disposed between two polarizing plates 41 and 42. The polarizing plate 42 is a λ/2 plate and has a protective film on the viewer side (upper side of the drawing). In the liquid crystal cell 43, liquid crystal molecules (46a and 46b) are sealed between glass substrates 44 and 45. A transparent anode 47 and a transparent cathode 48 are formed on the glass substrate 44. In the state of no voltage applied, the liquid crystal molecules are aligned in parallel to the transparent anode 47 and the transparent cathode 48 like the liquid crystal molecules 46a, but the liquid crystal molecules horizontally rotate by 90 degrees by voltage application and are aligned along the transparent anode 47 and the transparent cathode 48 like the liquid crystal molecules 46b. In a case where liquid crystal molecules rotate 90 degrees in the in-plane direction with no application and application, transmission and shielding are produced between the two polarizing plates.

Since the IPS-type liquid crystal display device of the present embodiment comprises the polarizing plate including the antireflection film according to the embodiment of the present invention, there is no external light reflection, and there is no reflected glare of an image on the screen, such that a clear image can be obtained.

[Antireflection Product]

The antireflection film according to the embodiment of the present invention can be applied to the antireflection product. Since the antireflection film according to the embodiment of the present invention has bending resistance and does not have fluctuation of the reflectance before and after the deformation, the antireflection film can be used in an antireflection product having a three-dimensional shape. Examples of the antireflection product having a three-dimensional shape include windshields and rear glasses of cars, cover glasses of speed meters, car interior parts, and glass showcases.

### EXAMPLES

Hereinafter, examples of the present invention are described. The present invention is not limited to the following examples.

An antireflection film comprising a hard coat layer and an antireflection layer was manufactured on the support by the method of manufacturing an antireflection film. Details are be described below.

<Support>

(Manufacturing of Support S-1)

A water-soluble acrylate polymer solution (DIC Corporation, UV100A) was used and cast on an endless belt at 100° C. by using a T die such that the final film thickness became 40 μm, was dried such that the polymer concentration became 40 mass %, and was peeled off from the endless belt. Subsequently, the film including the solvent was stretched 1.1 times in the MD direction in the atmosphere at 40° C. The film was stretched 1.2 times in the TD direction in a drying oven at 130° C. to obtain a support S-1 (elongation rate: 45%) having a thickness of 40 μm and formed of water-soluble acrylate.

(Manufacturing of Support S-2)

Rubber particles having a core-shell structure (KANE ACE M-210 manufactured by Kaneka Corporation) were melted by heating for two minutes by applying a pressure of 30 MPa at 220° C. with a heating press machine (Mini test press manufactured by Tokyo Seiki Seisaku-Sho, Ltd.), and the pressure was opened to normal temperature/normal pressure so as to manufacture a support film S-2 (elongation rate: 334%) with a thickness of 40 μm.

(Manufacturing of Support S-3)

[Synthesis of Aromatic Polyamide]

674.7 kg of N-methyl-2-pyrrolidone, 10.6 g of anhydrous lithium bromide (manufactured by Sigma-Aldrich Japan K.K.), 33.3 g of 2,2′-ditrifluoromethyl-4,4′-diaminobiphenyl (“TFMB” manufactured by Toray Fine Chemical Co., Ltd.), and 2.9 g of 4,4′-diaminodiphenylsulfone (“44 DDS” manufactured by Wakayama Seika Co., Ltd.) were added to a polymerization tank comprising a stirrer. The mixture in the polymerization tank was cooled to 15° C. and stirred under a nitrogen atmosphere, and 18.5 g of terephthalic acid dichloride (manufactured by Tokyo Chemical Industry Co., Ltd.) and 6.4 g of 4,4′-biphenyl dicarbonyl chloride (“4 BPAC” manufactured by Toray Fine Chemical Co., Ltd.) were added in 4 portions over 300 minutes. After stirring for 60 minutes, hydrogen chloride generated in the reaction was neutralized with lithium carbonate so as to obtain a polymer solution.

A portion of the polymer solution obtained above was cast on an endless belt at 120° C. using a T die such that the final film thickness became 40 μm, was dried such that the polymer concentration became 40 mass %, and was peeled off from the endless belt. Subsequently, the film including the solvent was stretched 1.1 times in the MD direction in the atmosphere at 40° C. and washed with water at 50° C., so as to remove the solvent. The film was stretched 1.2 times in the TD direction in a drying oven at 340° C. to obtain a support S-3 (elongation rate: 14%) having a thickness of 40 μm and formed of aromatic polyamide.

<Forming of Hard Coat Layer>

In other examples and comparative examples except for Examples 1 to 3 and Comparative Example 105, a hard coat layer was formed.

The support was coated with a coating liquid for a hard coat layer, which is described below, by using a die coater. After drying at 30° C. for 90 seconds and then at 60° C. for one minute, nitrogen purging was performed with an air cooling metal halide lamp (manufactured by Eye Graphics Co., Ltd.) of 160 W/cm such that the atmosphere had an oxygen concentration of about 0.3 vol %, the coating layer was cured by being irradiated with ultraviolet rays having an illuminance of 200 mW/cm² and an irradiation amount of 60 mJ/cm² to form a hard coat layer having a thickness of 10 μm.

(Preparation of Composition for Forming Hard Coat Layer)

Each component was added in the following composition, and the obtained composition was introduced to a mixing tank, stirred, and filtrated with a polypropylene filter having a pore size 0.4 μm so as to obtain coating liquids HC-1 to HC-6 for a hard coat layer.

—Coating liquid HC-1 for Hard Coat Layer—

| | | |
|---|---|---|
| UA-122P (Urethane acrylate, manufactured by | 33.6 | parts by mass |
| Shin-Nakamura Chemical Co., Ltd.) | | |
| IRGACURE 127 (Photopolymerization initiator, | 1.4 | parts by mass |
| manufactured by BASF Japan Ltd.) | | |
| Methyl ethyl ketone (MEK) | 35.8 | parts by mass |
| Methyl acetate | 29.2 | parts by mass |

—Coating Liquid HC-2 for Hard Coat Layer—

The same formulation as the coating liquid HC-1 for a hard coat layer was used, except that UV2750B (ultraviolet-curable urethane acrylate, manufactured by The Nippon Synthetic Chemical Industry Co., Ltd.) was used instead of UA-122P.

—Coating Liquid HC-3 for Hard Coat Layer—

The same formulation as the coating liquid HC-1 for a hard coat layer was used, except that BAC-45 (urethane acrylate (manufactured by Shin Nakamura Chemical Co., Ltd.)) was used instead of UA-122P.

—Coating Liquid HC-4 for Hard Coat Layer—

The same formulation as the coating liquid HC-1 for a hard coat layer was used, except that 22.5 parts by mass of A-TMMT (pentaerythritol tetraacrylate, manufactured by Shin Nakamura Chemical Co., Ltd.) and 11.1 parts by mass of AD-TMP (Ditrimethylolpropane tetraacrylate manufactured by Shin Nakamura Chemical Co., Ltd.) were used instead of UA-122P.

—Coating Liquid HC-5 for Hard Coat Layer—

The same formulation as the coating liquid HC-1 for a hard coat layer was used, except that KAYARAD DPCA20 (a hexafunctional acrylate monomer (manufactured by Nippon Kayaku Co., Ltd.)) was used instead of UA-122P.

—Coating Liquid HC-6 for Hard Coat Layer—

The same formulation as the coating liquid HC-1 for a hard coat layer was used, except that DPHA (dipentaerythritol hexaacrylate and dipentaerythritol pentaacrylate mixture) was used instead of UA-122P.

<Antireflection Layer>

(Manufacturing of Silica Particle Dispersion Liquid PA-1)

50 g of the silica particle treated with a silane coupling agent (KEA-18 average primary particle diameter 180 nm, manufactured by Nippon Shokubai Co., Ltd.), 200 g of methyl ethyl ketone (MEK), and 600 g of zirconia beads having a diameter of 0.05 nun were introduced in a 1 L bottle container having a diameter of 12 cm, set in a ball mill V-2M (IRIE SHOKAI Co., Ltd.), and dispersed for 10 hours at 250 rotation/min. In this manner, a silica particle dispersion liquid PA-1 (concentration of solid content: 20 mass %) was manufactured.

(Synthesis of Compound C3)

19.3 g of KBE-9007 manufactured by Shin-Etsu Chemical Co. Ltd., 3.9 g of glycerin 1,3-bisacrylate, 6.8 g of 2-hydroxyethyl acrylate, 0.1 g of dibutyltin dilaurate, and 70.0 g of toluene were added to a flask equipped with a reflux condenser and a thermometer and were stirred at room temperature for 12 hours, After stirring, 500 ppm of methylhydroquinone was added, and distillation under reduced pressure was performed, so as to obtain a compound C3. The compound C3 is a curable compound.

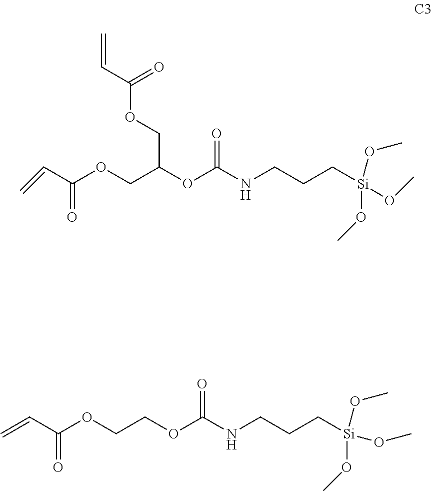

(Preparation of Composition for Forming First Layer)

Each component was introduced to a mixing tank so as to have the following composition, was stirred for 60 minutes, and was dispersed by an ultrasonic disperser for 30 minutes to prepare compositions (A-1) to (A-4).

—Composition (A-1)—

| | | |
|---|---|---|
| UV6630B (urethane acrylate oligomer, | 1.0 | part by mass |
| manufactured by DIC Corporation) | | |
| Compound C3 | 8.7 | parts by mass |
| IRGACURE 127 (Photopolymerization initiator, | 0.4 | parts by mass |
| manufactured by BASF Japan Ltd.) | | |
| Compound P (2-(4-Methoxyphenyl)-4,6- | 0.1 | parts by mass |
| bis(trichloromethyl)-1,3,5-triazine (photoacid | | |
| generator, manufactured by Tokyo Chemical | | |
| Industry Co., Ltd.)) | | |
| Silica particle dispersion liquid PA-1 | 25.4 | parts by mass |
| Compound A: F-784-F (manufactured by DIC | 0.10 | parts by mass |
| Corporation) | | |
| Ethanol | 15.0 | parts by mass |
| Methyl ethyl ketone | 34.4 | parts by mass |
| Acetone | 15.0 | parts by mass |

—Composition (A-2)—

| | | |
|---|---|---|
| UV7510B (urethane acrylate oligomer, | 1.0 | part by mass |
| manufactured by DIC Corporation) | | |
| Compound C3 | 8.7 | parts by mass |
| IRGACURE 127 (Photopolymerization initiator, | 0.4 | parts by mass |
| manufactured by BASF Japan Ltd.) | | |
| Compound P (2-(4-Methoxyphenyl)-4,6- | 0.1 | parts by mass |
| bis(trichloromethyl)-1,3,5-triazine (photoacid | | |
| generator, manufactured by Tokyo Chemical | | |
| Industry Co., Ltd.)) | | |
| Silica particle dispersion liquid PA-1 | 25.4 | parts by mass |
| Compound A: F-784-F (manufactured by DIC | 0.10 | parts by mass |
| Corporation) | | |
| Ethanol | 15.0 | parts by mass |
| Methyl ethyl ketone | 34.4 | parts by mass |
| Acetone | 15.0 | parts by mass |

—Composition (A-3)—

| | | |
|---|---|---|
| BAC-45 (polybutadiene terminal diacrylate | 1.0 | part by mass |
| manufactured by Osaka Organic Chemical | | |
| Industry Co., Ltd.) | | |
| Compound C3 | 8.7 | parts by mass |
| IRGACURE 127 (Photopolymerization initiator, | 0.4 | parts by mass |
| manufactured by BASF Japan Ltd.) | | |
| Compound P (2-(4-Methoxyphenyl)-4,6- | 0.1 | parts by mass |
| bis(trichloromethyl)-1,3,5-triazine (photoacid | | |
| generator, manufactured by Tokyo Chemical | | |
| Industry Co., Ltd.)) | | |
| Silica particle dispersion liquid PA-1 | 25.4 | parts by mass |
| Compound A: F-784-F (manufactured by DIC | 0.10 | parts by mass |
| Corporation) | | |
| Ethanol | 15.0 | parts by mass |
| Methyl ethyl ketone | 34.4 | parts by mass |
| Acetone | 15.0 | parts by mass |

—Composition (A-4)—

| | | |
|---|---|---|
| Sirius501 (Dendrimer polyfunctional acrylate, | 1.0 | part by mass |
| manufactured by Osaka Organic Chemical | | |
| Industry Ltd.) | | |
| Compound C3 | 8.7 | parts by mass |
| IRGACURE 127 (Photopolymerization initiator, | 0.4 | parts by mass |
| manufactured by BASF Japan Ltd.) | | |
| Compound P (2-(4-Methoxyphenyl)-4,6- | 0.1 | parts by mass |
| bis(trichloromethyl)-1,3,5-triazine (photoacid | | |
| generator, manufactured by Tokyo Chemical | | |
| Industry Co., Ltd.)) | | |
| Silica particle dispersion liquid PA-1 | 25.4 | parts by mass |
| Compound A: F-784-F (manufactured by DIC | 0.10 | parts by mass |
| Corporation) | | |
| Ethanol | 15.0 | parts by mass |
| Methyl ethyl ketone | 34.4 | parts by mass |
| Acetone | 15.0 | parts by mass |

<Preparation of Antireflection Film>

(First Step: Coating of First Layer)

The support was coated with 2.8 ml/m² of the composition for forming a first layer by using a die coater and dried at 30° C. for 90 seconds.

(Second Step: Bonding of Pressure Sensitive Adhesive Film)

Subsequently, the pressure sensitive adhesive film obtained by peeling off a release film from a protective film (MASTACK TFB AS3-304) manufactured by Fujimori Kogyo Co., Ltd. was bonded to the dried first layer such that the pressure sensitive adhesive layer on the first layer. The bonding was performed at a speed of 1 by using a commercial laminator Bio330 (manufactured by DAE-EL Co.).

The protective film herein refers to a laminate formed of the substrate, the pressure sensitive adhesive layer, and the release film, and a laminate obtained by peeling off the release film from the protective film and formed of the substrate and the pressure sensitive adhesive layer was a pressure sensitive adhesive film.

Details of the protective film used are provided below.
MASTACK TFB AS3-304 (manufactured by Fujimori Kogyo Co., Ltd., Optical protective film with antistatic function) (hereinafter also referred to as “AS3-304”)

Substrate: Polyester film (thickness: 38 μm)

Thickness of pressure sensitive adhesive layer: 20 μm

Maximum transmittance at wavelength of 250 nm to 300 nm in state in which release film was peeled off: Less than 0.1%

The transmittance was measured using an ultraviolet-visible-near infrared spectrophotometer UV3150 manufactured by Shimadzu Corporation.

(Third Step: Permeation of Curable Compound into Hard Coat Layer)

While the pressure sensitive adhesive film was bonded, heating was performed at 120° C. for 15 minutes such that a portion of the curable compound permeated the hard coat layer.

(Fourth Step: Curing of First Layer)

Subsequently to the heating, the surface side covered with the first layer was irradiated with ultraviolet rays having an illuminance of 200 mW/cm² and an irradiation amount of 300 mJ/cm² by using an air cooling metal halide lamp (manufactured by Eye Graphics Co., Ltd.) of 160 W/cm while purging was performed with nitrogen such that the atmosphere had an oxygen concentration of 0.01 vol % or less, so as to cure the first layer.

(Fifth Step: Peeling of Pressure Sensitive Adhesive Film)

The pressure sensitive adhesive film was peeled off from the prepared laminate. After the pressure sensitive adhesive film (film obtained by peeling off the release film from MASTACK TFB AS3-304) was peeled off, methyl isobutyl ketone was poured over the surface to which the pressure sensitive adhesive film had been bonded, so as to wash out the residue of the pressure sensitive adhesive layer. Thereafter, the film was dried at 25° C. for 10 minutes to obtain an antireflection film.

### Example 1

An antireflection film was manufactured by the above manufacturing method with S-1 as the support and a composition A-1 for forming a first layer.

### Example 2

Manufacturing was performed in the same manner as in Example 1, except that A-2 was used as the composition for forming a first layer.

### Example 3

Manufacturing was performed in the same manner as in Example 1, except that A-3 was used as the composition for forming a first layer.

### Example 4

Manufacturing was performed in the same manner as in Example 1, except that the coating liquid HC-1 for a hard coat layer was used.

### Example 5

Manufacturing was performed in the same manner as in Example 4, except that A-2 was used as the composition for forming a first layer.

### Example 6

Manufacturing was performed in the same manner as in Example 4, except that A-3 was used as the composition for forming a first layer.

### Example 7

Manufacturing was performed in the same manner as in Example 1, except that the coating liquid HC-2 for a hard coat layer was used.

### Example 8

Manufacturing was performed in the same manner as in Example 7, except that A-2 was used as the composition for forming a first layer.

### Example 9

Manufacturing was performed in the same manner as in Example 7, except that A-3 was used as the composition for forming a first layer.

### Example 10

Manufacturing was performed in the same manner as in Example 1, except that the coating liquid HC-3 for a hard coat layer was used.

### Example 11

Manufacturing was performed in the same manner as in Example 10, except that A-2 was used as the composition for forming a first layer.

### Example 12

Manufacturing was performed in the same manner as in Example 10, except that A-3 was used as the composition for a first layer.

### Example 13

Manufacturing was performed in the same manner as in Example 4, except that S-2 was used as the support.

### Example 14

Manufacturing was performed in the same manner as in Example 5, except that S-2 was used as the support.

### Example 15

Manufacturing was performed in the same manner as in Example 9, except that S-2 was used as the support.

### Example 16

Manufacturing was performed in the same manner as in Example 7, except that S-2 was used as the support.

### Example 17

Manufacturing was performed in the same manner as in Example 11, except that S-2 was used as the support.

### Example 18

Manufacturing was performed in the same manner as in Example 12, except that S-2 was used as the support.

### Comparative Example 101

Manufacturing was performed in the same manner as in Example 4, except that FUJITAC TG60UL (cellulose acylate film, manufactured by FUJIFILM Corporation) was used as the support, the composition A-4 for forming a first layer was used, and the coating liquid HC-4 for a hard coat layer was used.

### Comparative Example 102

Manufacturing was performed in the same manner as in Example 4, except that COSMOSHINE A-4300 (biaxially stretched polyester film, manufactured by Toyobo Co., Ltd.) having a thickness of 38 μm was used as the support, the coating liquid HC-5 for a hard coat layer was used, and the composition A-4 for an antireflection layer was used.

### Comparative Example 103

Manufacturing was performed in the same manner as in Example 4, except that S-3 was used as the support, the coating liquid HC-6 for a hard coat layer was used, and the composition A-4 for forming a first layer was used.

### Comparative Example 104

Manufacturing was performed in the same manner as in Example 4, except that SC50NNS (silicone rubber sheet, manufactured by Kureha Elastomer Co., Ltd.) having a thickness of 100 μm was used as the support, the coating liquid HC-5 for a hard coat layer was used, and the composition A-2 for forming a first layer was used.

### Comparative Example 105

Manufacturing was performed in the same manner as in Example 1, except that S-2 was used as the support, and the composition A-4 for forming a first layer was used.

[Method of Evaluating Antireflection Film]

The antireflection film was evaluated as follows.

<Bending Resistance and Reflectance Difference>

A bending endurance tester (MIT, BE-201 type, bending diameter: 0.8 mm, manufactured by Tester Sangyo Co., Ltd.) was used, and a sample film having a width of 15 mm and a length of 80 mm which is left for one hour or longer at 25° C. and 65% RH was used. The sample film was bent 2,000 times under the condition of a load of 500 g in conformity with JIS P8115, and the reflectance difference between a bent portion and a normal portion (unbent portion) was measured. Since the reflectance of the unbent portion is the same as the reflectance before deformation, the reflectance difference between the bent portion and the normal portion was obtained as the reflectance difference before and after the deformation.

(Evaluation Standard)

A: The reflectance change in a case of being bent (outwardly bent) in three axes (X, X+60° direction, and X+120° direction) was Δ0.5% or less

B: The reflectance change in a case of being bent (outwardly bent or inwardly bent) in two axes (X and X+90° directions) was Δ0.5% or less

C: The reflectance change in a case of being bent (outwardly bent or inwardly bent) in two axes (X and X+90° directions) was Δ1.0% or less

D: The reflectance change in a case of being bent (outwardly bent or inwardly bent) in two axes (X and X+90° directions) was more than Δ1.0%

E: The reflectance change in a case of being folded (outwardly bent or inwardly bent) in one axis (X direction) was more than Δ1.0%

<Reflectance>

With respect to the antireflection film, in a state in which the back surface (support side) of the film was roughened with sandpaper, an oily black ink (magic ink for supplement: Teranishi Chemical Industry Co., Ltd.) was applied such that back surface reflection was eliminated, an adapter ARV-474 was attached to a spectrophotometer V-550 (manufactured by JASCO Corporation), and the reflectance at an incidence angle of 5° in the wavelength range of 380 to 780 nm was measured to obtain the integrated reflectance.

<Distance Between Particles>

An antireflection film sample was cut with a microtome to obtain a cross section, and an etching treatment was performed on the cross section for 10 minutes after carbon vapor deposition. Twenty visual fields were observed and imaged at 5,000 times with a scanning electron microscope (SEM). In the obtained image, the distance between the peaks of adjacent protrusions was measured at 100 points on the interface formed by air and the sample and was calculated as an average value the distance between particles.

<Scratch Resistance>

A rubbing test was performed on the surface of the antireflection layer side of the antireflection film by using a rubbing tester under the following conditions so as to obtain an index of scratch resistance.

(Conditions)

Evaluation environment condition: 25° C., 60% RH

Rubbing material: Steel wool (manufactured by Nippon Steel Wool Co., Ltd., Grade No. 0000)

A band was wrapped around a rubbing front end section (1 cm×1 cm) of the tester in contact with the sample and was fixed.

Travel distance (one way): 13 cm

Rubbing speed: 13 cm/sec

Load: 50 g/cm²

Front end section contact area: 1 cm×1 cm

Number of rubbing: 10 round trips

Oily black ink was applied to the back side of the rubbed sample, and a reflectance was measured, so as to evaluate scratches on the rubbed portion.

(Evaluation Standard)

A: The reflectance difference between a steel wool rubbed portion and a normal portion (non-rubbed portion) was within Δ0.1%

B: The reflectance difference between a steel wool rubbed portion and a portion (non-rubbed portion) was more than 0.1% and within Δ0.2%

C: The reflectance difference between a steel wool rubbed portion and a normal portion (non-rubbed portion) was more than 0.2% and within Δ0.5%

<Etching Rate Ratio>

The surface of the antireflection layer 12 was etched with an argon gas that had been plasmatized under the condition of 13.56 MHz using a high frequency plasma device. The plasma treatment was performed by applying high frequency of 50 W for 25 seconds under the condition of a pressure of 2.7 Pa while gas of composition of oxygen:argon=1:1 was introduced. SEM observation was performed on the surface and the cross section of the antireflection film, fine particle repeating periodicity of 380 nm or less was checked by the surface observation, and the binder height was obtained by cross section observation before etching and after etching, so as to calculate an etching rate ratio of the binder with respect to the fine particles.

<Film Elongation Rate>

In accordance with JIS K5600, the antireflection film was cut such that the length in the measurement direction was 100 mm and the width was 10 mm, and immediately after the antireflection film was being left for two hours in an environment of 25° C. and 60% RH, a fully automatic tension tester manufactured by INTESCO Co. Ltd. was used, and elongation at break in a case of being stretched at a length between chucks of 100 mm and a tension rate of 10%/min in an atmosphere of 25° C. and 60% RH was set as elongation.

<Support Transmittance>

The total light transmittance of the support was measured using a haze meter (NDH2000, manufactured by Nippon Denshoku Industries Co., Ltd.). With respect to the measurement, measurement was performed in an environment of 25° C. and 55% RH based on JIS-K7136.

The configuration and evaluation results of the antireflection film are presented in Table 1.

TABLE 1

| | Support | | Hard coat layer | | Antireflection | | | | Distance | | | Film | |
|---|---|---|---|---|---|---|---|---|---|---|---|---|---|
| | | Thick- | | Thick- | layer | | | | between | | Etching | elon- | Support |
| | | ness | | ness | Binder | Fine | Bending | Reflect- | particles | Scratch | rate | gation | trans- |
| | Material | (μm) | Material | (μm) | material | particle | resistance | ance | (nm) | resistance | ratio | ratio | mittance |
| Example 1 | S-1 | 40 | — | | A-1 | KEA-18 | A | 0.9% | 208 | C | 41 | 12% | 90.0% |
| Example 2 | S-1 | 40 | — | — | A-2 | KEA-18 | A | 0.9% | 208 | C | 41 | 20% | 90.0% |
| Example 3 | S-1 | 40 | — | — | A-3 | KEA-18 | A | 0.9% | 208 | C | 41 | 45% | 90.0% |
| Example 4 | S-1 | 40 | HC-1 | 10 | A-1 | KEA-18 | C | 0.8% | 205 | A | 41 | 12% | 90.0% |
| Example 5 | S-1 | 40 | HC-1 | 10 | A-2 | KEA-18 | C | 0.8% | 205 | A | 41 | 20% | 90.0% |
| Example 6 | S-1 | 40 | HC-1 | 10 | A-3 | KEA-18 | C | 0.8% | 205 | A | 41 | 30% | 90.0% |
| Example 7 | S-1 | 40 | HC-2 | 10 | A-1 | KEA-18 | C | 0.9% | 208 | B | 41 | 12% | 90.0% |
| Example 8 | S-1 | 40 | HC-2 | 10 | A-2 | KEA-18 | C | 0.9% | 208 | B | 41 | 20% | 90.0% |
| Example 9 | S-1 | 40 | HC-2 | 10 | A-3 | KEA-18 | C | 0.9% | 208 | B | 41 | 40% | 90.0% |
| Example 10 | S-1 | 40 | HC-3 | 10 | A-1 | KEA-18 | B | 1.1% | 212 | C | 41 | 12% | 90.0% |
| Example 11 | S-1 | 40 | HC-3 | 10 | A-2 | KEA-18 | B | 1.1% | 212 | C | 41 | 20% | 90.0% |
| Example 12 | S-1 | 40 | HC-3 | 10 | A-3 | KEA-18 | B | 1.1% | 212 | C | 41 | 45% | 90.0% |
| Example 13 | S-2 | 40 | HC-1 | 10 | A-1 | KEA-18 | C | 0.8% | 205 | A | 41 | 20% | 85.0% |
| Example 14 | S-2 | 40 | HC-1 | 10 | A-2 | KEA-18 | C | 0.8% | 205 | A | 41 | 30% | 85.0% |
| Example 15 | S-2 | 40 | HC-2 | 10 | A-3 | KEA-18 | B | 0.9% | 208 | B | 41 | 20% | 85.0% |
| Example 16 | S-2 | 40 | HC-2 | 10 | A-1 | KEA-18 | B | 0.9% | 208 | B | 41 | 40% | 85.0% |
| Example 17 | S-2 | 40 | HC-3 | 10 | A-2 | KEA-18 | A | 1.1% | 212 | C | 41 | 20% | 85.0% |
| Example 18 | S-2 | 40 | HC-3 | 10 | A-3 | KEA-18 | A | 1.1% | 212 | C | 41 | 100% | 85.0% |
| Comparative | TG60UL | 60 | HC-4 | 6 | A-4 | KEA-18 | E | 0.6% | 195 | A | 27 | 1.5% | 92.0% |
| Example 101 | | | | | | | | | | | | | |
| Comparative | A-4300 | 38 | HC-5 | 5 | A-4 | KEA-18 | E | 0.8% | 205 | B | 27 | 2.3% | 90.0% |
| Example 102 | | | | | | | | | | | | | |
| Comparative | S-3 | 40 | HC-6 | 2 | A-4 | KEA-18 | D | 0.6% | 195 | A | 27 | 1.5% | 82.0% |
| Example 103 | | | | | | | | | | | | | |
| Comparative | SC50NNS | 100 | HC-5 | 5 | A-2 | KEA-18 | B | 0.8% | 205 | B | 41 | 2.5% | 50.0% |
| Example 104 | | | | | | | | | | | | | |
| Comparative | S-2 | 40 | — | — | A-4 | KEA-18 | D | 1.1% | 212 | C | 27 | 2.3% | 85.0% |
| Example 105 | | | | | | | | | | | | | |

As presented in Table 1, the antireflection film according to the embodiment of the present invention was excellent in bending resistance, scratch resistance, low reflectance, and support transmittance. In Examples 4 to 18 in which the hard coat layer was formed, the scratch resistance was excellent.

In the case where urethane acrylate (UA-122P) was used as the curable compound (Examples 4 to 6), the scratch resistance was excellent compared with a case where a urethane acrylate oligomer (UA2750B) was used (Examples 7 to 9), a case where polybutadiene terminal diacrylate (BAC-45) was used (Examples 10 to 12).

It is understood that, in a case where polybutadiene-terminated diacrylate (BAC-45) having an elongation at break of 100% is used as a curable compound of a binder, the elongation rate is higher compared with a case where a urethane acrylate oligomer (UB6630B or UV7510B) having an elongation at break of 12% or 20% was used.

Meanwhile, in Comparative Examples, Comparative Examples 101, 102, 103, and 105 in which a material having a small elongation at break was used as a support or a hard coat layer and a material having a three-dimensional crosslinked structure and having a small elongation rate was used as a binder were inferior in the bending resistance. It is understood that, even in the case where the spacer or the support having the rubber structure was used, Comparative Example 105 in which a material having a three-dimensional crosslinked structure and not having flexibility was used as the binder was inferior in the bending resistance. Comparative Example 104 in which a rubber sheet was used as the support was inferior in the support transmittance.

### EXPLANATION OF REFERENCES

10: antireflection film
11: support
12: antireflection layer
13: fine particle
14: binder
15: first layer
16: interface
17: layer obtained by combining first layer and pressure sensitive adhesive layer
20: polarizing plate
21: polarizing film
30: laminate
31: substrate
32: pressure sensitive adhesive layer
33: pressure sensitive adhesive film
40: IPS-type liquid crystal display device
41, 42: polarizing plate
43: liquid crystal cell
44, 45: glass substrate
46a, 46b: liquid crystal molecule
47: transparent anode
48: transparent cathode

What is claimed is:

1. An antireflection film comprising:
a support having a transmittance of 80% or more, and
an antireflection layer laminated on the support,
wherein a reflectance difference before and after deformation in a case of outward bending or inward bending with R of 0.8 mm in biaxial directions different by 90° is within 1.0%.

2. The antireflection film according to claim 1,
wherein the antireflection layer includes a binder and a fine particle and has a periodic structure having a period equal to or less than a visible light wavelength of 380 nm,
the fine particle has an average primary particle diameter of 150 nm to 250 nm,
the binder includes at least one of polyacrylate or polyurethane acrylate, and
an elongation rate of the antireflection film is 10% or more.

3. The antireflection film according to claim 2,
wherein a hardness of the fine particle is 400 MPa or more.

4. The antireflection film according to claim 1, further comprising:
a hard coat layer between the support and the antireflection layer.

5. The antireflection film according to claim 4,
wherein a thickness of the hard coat layer is 10 μm or less.

6. The antireflection film according to claim 1,
wherein an elongation rate of the support is 20% or more.

7. The antireflection film according to claim 6,
wherein a thickness of the support is 60 μm or more.

8. The antireflection film according to claim 1,
wherein a surface of the antireflection layer repeatedly includes regions where an etching rate in a case where the surface of the antireflection layer is etched with argon gas plasmatized at 13.56 MHz differs by 10 times or more, at a period of 380 nm or less.

9. The antireflection film according to claim 1,
wherein in a case where steel wool of a grade (count) #0000 which is manufactured by Nippon Steel Wool Co., Ltd (product number B-204) is wrapped around a front end section of a 1 cm square of a rubbing tester, and a surface of the antireflection layer opposite to the support is rubbed with a load of 50 g/cm², a reflectance difference between a rubbed portion and a non-rubbed portion is within 0.2%.

10. The antireflection film according to claim 1,
wherein a reflectance difference before and after deformation in a case of outward bending with R of 0.8 mm in triaxial directions different by 60° is within 1.0%.

11. A polarizing plate comprising:
the antireflection film according to claim 1 as a protective film.

12. An image display device comprising:
the antireflection film according to claim 1.

13. The image display device comprising:
the polarizing plate according to claim 11.

14. An antireflection product comprising:
the antireflection film according to claim 1.

15. A method of manufacturing a laminate, comprising, in this order:
a first step of coating a support with a curable composition including a curable compound and a fine particle having an average primary particle diameter of 150 nm to 250 nm and a hardness of 400 MPa or more, to provide a first layer in a thickness in which the fine particle is buried in the first layer including the curable compound;
a second step of bonding a pressure sensitive adhesive layer of a pressure sensitive adhesive film having a substrate and the pressure sensitive adhesive layer provided on the substrate to a surface of the first layer opposite to the support;
a third step of lowering a position of an interface between the first layer and the pressure sensitive adhesive layer to the support side such that the fine particle is buried in a layer obtained by combining the first layer and the pressure sensitive adhesive layer and the fine particle protrudes from the interface opposite to an interface of the first layer on the support side; and
a fourth step of curing the first layer in a state in which the fine particle is buried in the layer obtained by combining the first layer and the pressure sensitive adhesive layer,
wherein an elongation rate after the pressure sensitive adhesive film is peeled off is 10% or more.

16. A method of manufacturing an antireflection film, comprising, in this order:
a first step of coating a support with a curable composition including a curable compound and a fine particle having an average primary particle diameter of 150 nm to 250 nm and a hardness of 400 MPa or more, to provide a first layer in a thickness in which the fine particle is buried in the first layer including the curable compound;
a second step of bonding a pressure sensitive adhesive layer of a pressure sensitive adhesive film having a substrate and the pressure sensitive adhesive layer provided on the substrate to a surface of the first layer opposite to the support;
a third step of lowering a position of an interface between the first layer and the pressure sensitive adhesive layer to the support side such that the fine particle is buried in a layer obtained by combining the first layer and the pressure sensitive adhesive layer and the fine particle protrudes from the interface opposite to an interface of the first layer on the support side;
a fourth step of curing the first layer in a state in which the fine particle is buried in the layer obtained by combining the first layer and the pressure sensitive adhesive layer; and
a fifth step of peeling off the pressure sensitive adhesive film,
wherein an elongation rate is 10% or more.
